(19) United States
(12) Patent Application Publication
(10) Pub. No.: US 2025/0338058 A1
(43) Pub. Date: Oct. 30, 2025

(54) DATA PROCESSING METHOD AND RELATED DEVICE

(71) Applicant: Huawei Technologies Co., Ltd., Shenzhen (CN)

(72) Inventors: Zhida Sun, Shenzhen (CN); Wenhao Wu, Shenzhen (CN); Qiang Xu, Toronto (CA); Chenhe Li, Toronto (CA); Zhe Liu, Toronto (CA); Salam Gabran, Toronto (CA); Nu Zhang, Shenzhen (CN); Yanshan He, Shenzhen (CN); Taizhou Chen, Shenzhen (CN); Yibin Zhai, Shenzhen (CN)

(21) Appl. No.: 18/695,497

(22) PCT Filed: Sep. 30, 2022
(86) PCT No.: PCT/CN2022/122997

§ 371 Date: Sep. 10, 2024

(30) Foreign Application Priority Data
Sep. 30, 2021 (CN) 202111166702.3

(51) Int. Cl. H04R 1/10

(52) U.S. Cl. CPC H04R 1/1091; H04R 1/1016

(57) ABSTRACT

In accordance with an embodiment, a method includes obtaining a first feedback signal corresponding to a first sounding signal, where the first sounding signal is an audio signal transmitted using a target earbud of a headset, a frequency band of the first sounding signal is 8 kHz to 20 kHz, and the first feedback signal comprises a reflected signal corresponding to the first sounding signal; and in response to the headset being worn, determining, based on the first feedback signal, a first detection result corresponding to the target earbud, wherein the first detection result indicates that the target earbud is worn on a left ear or a right ear

### CROSS-REFERENCE TO RELATED APPLICATIONS

This application is a National Stage of International Application No. PCT/CN2022/122997, filed on Sep. 30, 2022, which claims priority to Chinese Patent Application No. 202111166702.3, filed on Sep. 30, 2021, both of which are hereby incorporated by reference in their entireties.

### TECHNICAL FIELD

This application relates to the artificial intelligence field, and in particular, to a data processing method and a related device.

### BACKGROUND

With development of science and technology, headsets become increasingly popular products. Invention of headsets such as a Bluetooth headset and a wireless headset enables a user to have larger activity space when using the headset. The user can more conveniently listen to an audio, watch a video, experience a virtual reality (virtual reality, VR) game, and the like.

Currently, a mainstream manner is that two earbuds of one headset are marked with left (left, L) and right (right, R) in advance. The user needs to respectively wear the two earbuds on the left ear and the right ear based on marks on the two earbuds. However, the two earbuds may be worn reversely by the user. When the headset plays a stereo audio, wearing the earbuds reversely may cause a voice heard by the user to be unnatural.

### SUMMARY

Embodiments of this application provide a data processing method and a related device, to detect an actual wearing status of each target earbud according to an acoustic principle. In other words, a user does not need to view a mark on the earbud, and wear a headset based on marks on earbuds. This simplifies an operation of the user, and helps improve customer stickiness in this solution. Because a speaker and a microphone are usually disposed inside the headset, no additional hardware is required, and manufacturing costs are reduced.

To resolve the foregoing technical problem, embodiments of this application provide the following technical solutions:

According to a first aspect, an embodiment of this application provides a data processing method that may be used in the field of smart headsets. One headset includes two target earbuds, and the method includes: An execution device transmits a first sounding signal by using the target earbud. The first sounding signal is an audio signal, a frequency band of the first sounding signal is 8 kHz to 20 kHz, and the execution device may be a headset or an electronic device connected to the headset. The execution device collects, by using the target earbud, a first feedback signal corresponding to the first sounding signal, where the first feedback signal includes a reflected signal corresponding to the first sounding signal. When it is detected that the headset is worn, the execution device determines, based on the first feedback signal corresponding to the first sounding signal, a first detection result corresponding to each target earbud, where one first detection result indicates that one target earbud is worn on a left ear or a right ear. With reference to the foregoing descriptions, it can be learned that when the first feedback signal includes the reflected signal corresponding to the first sounding signal, that is, the execution device collects the first sounding signal by using the target earbud that sends the first sounding signal, and a user wears only one target earbud, the execution device may also obtain the first feedback signal corresponding to the first sounding signal, and determine, based on the first feedback signal, whether the worn target earbud is worn on the left ear or the right ear.

In this implementation, the first sounding signal is transmitted by using the target earbud, the first feedback signal corresponding to the first sounding signal is obtained by using the target earbud, and whether the target earbud is worn on the left ear or the right ear of the user is determined based on the first feedback signal. It can be learned from the foregoing solution that, in this application, a category of each earbud is not preset. Instead, after the user wears the earbud, whether the target earbud is worn on the left ear or the right ear is determined based on an actual wearing status of the user. In other words, the user does not need to view a mark on the earbud, and wear the headset based on the mark on the earbud, but may wear the headset randomly. This simplifies an operation of the user, and helps improve customer stickiness in this solution. In addition, an actual wearing status of each target earbud is detected according to an acoustic principle. Because a speaker and a microphone are usually disposed inside the headset, no additional hardware is required, and manufacturing costs are reduced. In addition, the frequency band of the first sounding signal is 8 kHz to 20 kHz. In other words, speakers in different headsets can accurately send first sounding signals, that is, the frequency band of the first sounding signal is not affected by a difference between different components, to help improve accuracy of a detection result.

In a possible implementation of the first aspect, the first sounding signal is an audio signal that varies at different frequencies, and the first sounding signal has same signal strength at the different frequencies. For example, the first sounding signal may be a linear chirp (chirp) signal or an audio signal of another type.

In a possible implementation of the first aspect, when any one or more of the following cases are detected, it is considered that it is detected that the headset is worn: it is detected that an application program of a preset type is opened, it is detected that a screen of an electronic device communicatively connected to the headset is on, or it is detected that the target earbud is placed on an ear. The application program of the preset type may be a video-type application program, a game-type application program, a navigation-type application program, another application program that may generate a stereo audio, or the like.

In this embodiment of this application, a plurality of cases in which a headset is detected to be worn are provided, to extend an application scenario of this solution. In addition, when the application program of the preset type is opened, and it is detected that the screen of the electronic device communicatively connected to the headset is on or that the target earbud is placed on the ear, an audio is not played by using the headset, that is, an actual wearing status of the earbud is detected before the audio is actually played by using the headset. This helps assist the headset in correctly playing an audio, to further improve customer stickiness in this solution.

In a possible implementation of the first aspect, the method further includes: The execution device obtains a plurality of groups of target feature information corresponding to a plurality of wearing angles of the target earbud. Each group of target feature information includes feature information of a second feedback signal obtained when the target earbud on the left ear is worn at a target wearing angle, and feature information of a second feedback signal obtained when the target earbud on the right ear is worn at the target wearing angle, that is, each piece of target feature information includes feature information of a second feedback signal corresponding to one wearing angle of the target earbud. The second feedback signal includes a reflected signal corresponding to a second sounding signal, and the second sounding signal is an audio signal transmitted by using the target earbud. That the execution device determines, based on the first feedback signal, a first detection result corresponding to the target earbud includes: The execution device determines the first detection result based on the first feedback signal and the plurality of groups of target feature information.

In this embodiment of this application, a plurality of pieces of target feature information corresponding to the plurality of wearing angles of the target earbud may further be obtained, and each piece of target feature information includes feature information of a second feedback signal corresponding to one wearing angle of the target earbud. Further, the first detection result is obtained based on the first feedback signal and the plurality of pieces of target feature information corresponding to the plurality of wearing angles, to ensure that an accurate detection result can be obtained regardless of a wearing angle of the target earbud. This helps further improve accuracy of a finally obtained detection result.

In a possible implementation of the first aspect, that the execution device determines the first detection result based on the first feedback signal and the plurality of groups of target feature information may include: After detecting that the headset is worn, the execution device may use an inertial measurement unit disposed on the target earbud to obtain the target wearing angle at which the target earbud reflects the first sounding signal (or collects the first feedback signal), that is, the target wearing angle corresponding to the first feedback signal is obtained. The execution device obtains, from the plurality of pieces of target feature information corresponding to the plurality of wearing angles of the target earbud, a group of determined target feature information corresponding to the target wearing angle. The group of determined target feature information may include the feature information of the second feedback signal obtained when the earbud on the left ear is worn at the target wearing angle, and the feature information of the second feedback signal obtained when the earbud on the right ear is worn at the target wearing angle. The execution device calculates, based on the first feature information corresponding to the first feedback signal, a similarity between the first feature information and the feature information of the feedback signal obtained when the earbud on the left ear is worn at the target wearing angle, and a similarity between the first feature information and the feature information of the feedback signal obtained when the earbud on the right ear is worn at the target wearing angle, to determine the first detection result corresponding to the target earbud.

In a possible implementation of the first aspect, after the execution device determines the first detection result corresponding to the target earbud, the method further includes: The execution device obtains a second detection result corresponding to the target earbud. One second detection result indicates that one target earbud is worn on the left ear or the right ear, and the second detection result is obtained by detecting the target earbud for another time. If the first detection result is inconsistent with the second detection result, and a type of a to-be-played audio belongs to a preset type, the execution device outputs third prompt information. The to-be-played audio is an audio that needs to be played by using the target earbud, the third prompt information is used to query the user whether to correct a category of the target earbud, and the category of the target earbud is that the target earbud is worn on the left ear or the right ear. “Correcting the category of the target earbud” means changing the category of the earbud determined to be worn on the left ear to be worn on the right ear, and changing the category of the earbud determined to be worn on the right ear to be worn on the left ear.

In this implementation, accuracy of a finally determined wearing status of each earbud can be improved. In addition, the user corrects the detection result only when the type of the to-be-played audio belongs to the preset type, to reduce unnecessary disturbance to the user, and help improve customer stickiness in this solution.

In a possible implementation of the first aspect, the preset type includes any one or a combination of the following: a stereo audio, an audio from a video-type application program, an audio from a game-type application program, and an audio carrying direction information.

In this implementation, several specific types of preset types that need to be corrected by the user are provided, to improve implementation flexibility of this solution, and extend an application scenario of this solution. In addition, for several types of audios: a stereo audio, an audio from a video-type application program, an audio from a game-type application program, and an audio carrying direction information, if a wearing status, determined by the execution device, of each target earbud is inconsistent with an actual wearing status of the user, user experience is usually greatly affected. For example, when the to-be-played audio is an audio from a video-type application program or a game-type application program, if the determined wearing status of each target earbud is inconsistent with the actual wearing status of the user, a picture seen by the user cannot correctly match sound heard by the user. For another example, when the to-be-played audio is an audio carrying direction information, if the determined wearing status of each target earbud is inconsistent with the actual wearing status of the user, a playing direction of the to-be-played audio cannot correctly match content in the to-be-played audio. When the to-be-played audio is a preset audio, serious confusion is caused to the user. Therefore, in these cases, it is more necessary to ensure consistency between the determined wearing status of each target earbud and the actual wearing status of the user, to provide good use experience for the user.

In a possible implementation of the first aspect, after the execution device determines the first detection result corresponding to the target earbud, the method further includes: The execution device makes a prompt tone by using the target earbud, where the prompt tone is used to verify correctness of the first detection result. In this implementation, after the actual wearing status of each earbud is detected, at least one target earbud is further used to make the prompt tone, to verify a predicted first detection result. This ensures that a predicted wearing status of each earbud is consistent with the actual wearing status, to further improve customer stickiness in this solution.

In a possible implementation of the first aspect, the two target earbuds include a first earbud and a second earbud, the first earbud is determined to be worn in a first direction, and the second earbud is determined to be worn in a second direction. That the execution device makes a prompt tone by using the target earbud includes: The execution device outputs first prompt information through a first display interface when making a first prompt tone by using the first earbud, where the first prompt information indicates whether the first direction corresponds to the left ear or the right ear; and outputs second prompt information through the first display interface when making a second prompt tone by using the second earbud, where the second prompt information indicates whether the second direction corresponds to the left ear or the right ear. Specifically, in an implementation, the execution device may first keep the second earbud not making sound, and make the first prompt tone by using the first earbud; and then keep the first earbud not making sound, and make the second prompt tone by using the second earbud. In another implementation, the execution device may make sound by using both the first earbud and the second earbud, but a volume of the first prompt tone is far higher than a volume of the second prompt tone; and then make sound by using both the first earbud and the second earbud, but a volume of the second prompt tone is far higher than a volume of the first prompt tone.

In this implementation, the user may directly determine, by using the prompt information displayed on the display interface and the heard prompt tone, whether the wearing status (namely, the detection result corresponding to each target earbud) of each target earbud detected by the execution device is correct. This reduces difficulty in a process of verifying a detection result corresponding to each target earbud, does not increase additional cognitive burden of the user, facilitates the user to develop a new use habit, and helps improve customer stickiness in this solution.

In a possible implementation of the first aspect, the execution device may alternatively display a first icon through the first display interface, obtain, by using the first icon, a first operation input by the user, and trigger correction of the category of the target earbud in response to the obtained first operation. In other words, the category of the earbud determined based on the first detection result to be worn on the left ear is changed to be worn on the right ear, and the category of the earbud determined based on the first detection result to be worn on the right ear is changed to be worn on the left ear.

In a possible implementation of the first aspect, the two target earbuds include a first earbud and a second earbud, the first earbud is determined to be worn in a first direction, and the second earbud is determined to be worn in a second direction. The execution device obtains, from the first earbud and the second earbud, the earbud determined to be worn in a preset direction, and makes a prompt tone only by using the earbud determined to be worn in the preset direction. The preset direction may be the left ear of the user, or may be the right ear of the user.

In this embodiment of this application, the prompt tone is made only in the preset direction (namely, the left ear or the right ear of the user). In other words, if the prompt tone is made only by using the target earbud determined to be worn on the left ear, the user needs to determine whether the target earbud that makes the prompt tone is worn on the left ear. Alternatively, if the prompt tone is made only by using the target earbud determined to be worn on the right ear, the user needs to determine whether the target earbud that makes the prompt tone is worn on the right ear. This provides a new manner of verifying a detection result of the target earbud, and improves implementation flexibility of this solution.

In a possible implementation of the first aspect, the headset is an over-ear headset or an on-ear headset, the two target earbuds includes a first earbud and a second earbud, a first audio collection apparatus is disposed in the first earbud, and a second audio collection apparatus is disposed in the second earbud. When the headset is worn, the first audio collection apparatus corresponds to a helix area of a user, and the second audio collection apparatus corresponds to a concha area of the user; or when the headset is worn, the first audio collection apparatus corresponds to a concha area of a user, and the second audio collection apparatus corresponds to a helix area of the user. “Corresponding to the helix area of the user” may specifically be in contact with the helix area of the user, or may be suspended above the helix area of the user. Correspondingly, “corresponding to the concha area of the user” may specifically be in contact with the concha area of the user, or may be suspended above the concha area of the user.

In this implementation, because the helix area is an area with largest coverage of the headset, and the concha area is an area with smallest coverage of the headset, that is, if the audio collection apparatus corresponds to the helix area of the user, the collected first feedback signal is greatly weakened compared with the sent first sounding signal. If the audio collection apparatus corresponds to the concha area of the user, in comparison with the sent first sounding signal, a degree to which the collected first feedback signal is weakened is low, to further amplify a difference between the first feedback signals corresponding to the left ear and the right ear. This helps improve accuracy of a detection result corresponding to the target earbud.

In a possible implementation of the first aspect, the first audio collection apparatus corresponds to a helix area of the left ear, and the second audio collection apparatus corresponds to a concha area of the right ear; or the second audio collection apparatus corresponds to a helix area of the left ear, and the first audio collection apparatus corresponds to a concha area of the right ear. In other words, regardless of a manner in which the user wears the headset, one audio collection apparatus corresponds to the helix area of the left ear, and the other audio collection apparatus corresponds to the concha area of the right ear.

In a possible implementation of the first aspect, the first audio collection apparatus corresponds to a concha area of the left ear, and the second audio collection apparatus corresponds to a helix area of the right ear; or the second audio collection apparatus corresponds to a concha area of the left ear, and the first audio collection apparatus corresponds to a helix area of the right ear. In other words, regardless of a manner in which the user wears the headset, one audio collection apparatus corresponds to the concha area of the left ear, and the other audio collection apparatus corresponds to the helix area of the right ear.

In a possible implementation of the first aspect, that the execution device determines a first category of the target earbud based on the feedback signal includes: The execution device determines the first category of the target earbud based on the reflected signal (namely, a specific representation form of the feedback signal) corresponding to the collected sounding signal and an ear transfer function. The headset is an over-ear headset or an on-ear headset, and the ear transfer function is an ear auricle transfer function EATF; or the headset is an in-ear headset, a semi-in-ear headset, or an over-ear headset, and the ear transfer function is an ear canal transfer function ECTF.

In this implementation, a specific type of an ear transfer function used when the headset is in different forms is provided, to extend an application scenario of this solution, and improve flexibility of this solution.

In a possible implementation of the first aspect, when the first feedback signal includes the reflected signal corresponding to the first sounding signal, that is, the first feedback signal is collected by using the target earbud that transmits the first sounding signal, and the execution device detects that the target earbud (namely, any earbud of the headset) is worn, the execution device may determine, based on signal strength of the first feedback signal, target wearing information corresponding to the target earbud that collects the first feedback signal. The target wearing information indicates wearing tightness of the target earbud. It should be noted that if two target earbuds of the headset perform the foregoing operation, wearing tightness of each target earbud may be obtained.

In this embodiment of this application, not only actual wearing statuses of the two earbuds can be detected based on the acoustic signal, but also wearing tightness of the earbuds can be detected, to provide a more delicate service for a user. This further helps improve customer stickiness in this solution.

According to a second aspect, an embodiment of this application provides a data processing method. One headset includes two target earbuds. The method includes: An execution device obtains a first feedback signal corresponding to a first sounding signal. The first sounding signal is an audio signal transmitted by using the target earbud, and the first feedback signal includes a reflected signal corresponding to the first sounding signal. When detecting that the headset is worn, the execution device obtains a target wearing angle corresponding to the first feedback signal, where the target wearing angle is a wearing angle of the target earbud when the first feedback signal is collected. The execution device obtains target feature information corresponding to the target wearing angle, where the target feature information indicates feature information of a feedback signal obtained when the target earbud is at the target wearing angle. The execution device determines, based on the first feedback signal and the target feature information, a first detection result corresponding to the target earbud, where the first detection result indicates that each target earbud is worn on a left ear or a right ear.

In a possible implementation of the second aspect, both a frequency band of the first sounding signal and a frequency band of a second sounding signal are 8 kHz to 20 kHz.

The execution device provided in the second aspect in this embodiment of this application may further perform steps performed by the execution device in the possible implementations of the first aspect. For specific implementation steps of the second aspect and the possible implementations of the second aspect in this embodiment of this application, and beneficial effect brought by each possible implementation, refer to descriptions in the possible implementations of the first aspect. Details are not described herein again.

According to a third aspect, an embodiment of this application provides a data processing method that may be used in the field of smart headsets. One headset includes two target earbuds. The method may include: An execution device obtains a first detection result corresponding to the target earbud, where the first detection result indicates that each target earbud is worn on a left ear or a right ear; and makes a prompt tone by using the target earbud, where the prompt tone is used to verify correctness of the first detection result.

In a possible implementation of the third aspect, that an execution device obtains a first detection result corresponding to the target earbud includes: The execution device transmits a sounding signal by using the target earbud, where the sounding signal is an audio signal; collects, by using the target earbud, a feedback signal corresponding to the sounding signal, where the feedback signal includes a reflected signal corresponding to the sounding signal; and determines, based on the feedback signal, the first detection result corresponding to the target earbud.

In a possible implementation of the third aspect, after the execution device determines the first detection result corresponding to the target earbud, the method further includes: The execution device obtains a second detection result corresponding to the target earbud. The second detection result indicates that each target earbud is worn on the left ear or the right ear, and the second detection result is obtained by detecting the target earbud for another time. If the first detection result is inconsistent with the second detection result, and a type of a to-be-played audio belongs to a preset type, the execution device outputs third prompt information, where the third prompt information is used to query a user whether to correct a category of the target earbud, the to-be-played audio is an audio that needs to be played by using the target earbud, and the category of the target earbud is that the target earbud is worn on the left ear or the right ear.

In a possible implementation of the third aspect, the preset type includes any one or a combination of the following: a stereo audio, an audio from a video-type application program, an audio from a game-type application program, and an audio carrying direction information.

The execution device provided in the third aspect in this embodiment of this application may further perform steps performed by the execution device in the possible implementations of the first aspect. For specific implementation steps of the third aspect and the possible implementations of the third aspect in this embodiment of this application, and beneficial effect brought by each possible implementation, refer to descriptions in the possible implementations of the first aspect. Details are not described herein again.

According to a fourth aspect, an embodiment of this application provides a data processing method that may be used in the field of smart headsets. One headset includes two target earbuds. The method may include: An execution device obtains a first detection result corresponding to the target earbud, where the first detection result indicates that each target earbud is worn on a left ear or a right ear; and obtains a second detection result corresponding to the target earbud, where the second detection result indicates that each target earbud is worn on the left ear or the right ear, and the second detection result is obtained by detecting the target earbud for another time. If the first detection result is inconsistent with the second detection result, and a type of a to-be-played audio belongs to a preset type, the execution device outputs third prompt information. The third prompt information is used to query a user whether to correct a category of the target earbud, the to-be-played audio is an audio that needs to be played by using the target earbud, and the category of the target earbud is that the target earbud is worn on the left ear or the right ear.

In a possible implementation of the fourth aspect, that an execution device obtains a first detection result corresponding to the target earbud includes: The execution device transmits a first sounding signal by using the target earbud, where the first sounding signal is an audio signal; collects, by using the target earbud, a first feedback signal corresponding to the first sounding signal, where the first feedback signal includes a reflected signal corresponding to the first sounding signal; and determines, based on the first feedback signal, the first detection result corresponding to the target earbud.

The execution device provided in the fourth aspect in this embodiment of this application may further perform steps performed by the execution device in the possible implementations of the first aspect. For specific implementation steps of the fourth aspect and the possible implementations of the fourth aspect in this embodiment of this application, and beneficial effect brought by each possible implementation, refer to descriptions in the possible implementations of the first aspect. Details are not described herein again.

According to a fifth aspect, an embodiment of this application provides a data processing apparatus that may be used in the field of smart headsets. One headset includes two target earbuds, and the apparatus includes: an obtaining module, configured to obtain a first feedback signal corresponding to a first sounding signal, where the first sounding signal is an audio signal transmitted by using the target earbud, a frequency band of the first sounding signal is 8 kHz to 20 kHz, and the first feedback signal includes a reflected signal corresponding to the first sounding signal; and a determining module, configured to: when it is detected that the headset is worn, determine, based on the first feedback signal, a first detection result corresponding to the target earbud, where the first detection result indicates that the target earbud is worn on a left ear or a right ear.

The data processing apparatus provided in the fifth aspect in this embodiment of this application may further perform steps performed by the execution device in the possible implementations of the first aspect. For specific implementation steps of the fifth aspect and the possible implementations of the fifth aspect in this embodiment of this application, and beneficial effect brought by each possible implementation, refer to descriptions in the possible implementations of the first aspect. Details are not described herein again.

According to a sixth aspect, an embodiment of this application provides a data processing apparatus that may be used in the field of smart headsets. One headset includes two target earbuds, and the apparatus includes: an obtaining module, configured to obtain a first feedback signal corresponding to a first sounding signal, where the first sounding signal is an audio signal transmitted by using the target earbud, the first feedback signal includes a reflected signal corresponding to the first sounding signal, the obtaining module is further configured to: when it is detected that the headset is worn, obtain a target wearing angle corresponding to the first feedback signal, where the target wearing angle is a wearing angle of the target earbud when the first feedback signal is collected, and the obtaining module is further configured to obtain target feature information corresponding to the target wearing angle, where the target feature information indicates feature information of a feedback signal obtained when the target earbud is at the target wearing angle; and a determining module, configured to determine, based on the first feedback signal and the target feature information, a first detection result corresponding to the target earbud, where the first detection result indicates that each target earbud is worn on a left ear or a right ear.

The data processing apparatus provided in the sixth aspect in this embodiment of this application may further perform steps performed by the execution device in the possible implementations of the first aspect. For specific implementation steps of the sixth aspect and the possible implementations of the sixth aspect in this embodiment of this application, and beneficial effect brought by each possible implementation, refer to descriptions in the possible implementations of the first aspect. Details are not described herein again.

According to a seventh aspect, an embodiment of this application provides a data processing apparatus that may be used in the field of smart headsets. One headset includes two target earbuds, and the apparatus includes: an obtaining module, configured to obtain a first detection result corresponding to the target earbud, where the first detection result indicates that each target earbud is worn on a left ear or a right; and a prompt module, configured to make a prompt tone by using the target earbud, where the prompt tone is used to verify correctness of the first detection result.

The data processing apparatus provided in the seventh aspect in this embodiment of this application may further perform steps performed by the execution device in the possible implementations of the first aspect. For specific implementation steps of the seventh aspect and the possible implementations of the seventh aspect in this embodiment of this application, and beneficial effect brought by each possible implementation, refer to descriptions in the possible implementations of the first aspect. Details are not described herein again.

According to an eighth aspect, an embodiment of this application provides a computer program product. When the computer program is run on a computer, the computer is enabled to perform the data processing method in the first aspect, the second aspect, the third aspect, or the fourth aspect.

According to a ninth aspect, an embodiment of this application provides a computer-readable storage medium. The computer-readable storage medium stores a computer program, and when the computer program is run on a computer, the computer is enabled to perform the data processing method in the first aspect, the second aspect, the third aspect, or the fourth aspect.

According to a tenth aspect, an embodiment of this application provides an execution device, including a processor. The processor is coupled to a memory. The memory stores program instructions, and when the program instructions stored in the memory are executed by the processor, the data processing method in the first aspect, the second aspect, the third aspect, or the fourth aspect is implemented.

According to an eleventh aspect, an embodiment of this application provides a circuit system. The circuit system includes a processing circuit, and the processing circuit is configured to perform the data processing method in the first aspect, the second aspect, the third aspect, or the fourth aspect.

According to a twelfth aspect, an embodiment of this application provides a chip system. The chip system includes a processor, configured to implement functions in the foregoing aspects, for example, sending or processing data and/or information in the foregoing method. In a possible design, the chip system further includes a memory. The memory is configured to store program instructions and data that are necessary for a server or a communication device. The chip system may include a chip, or may include a chip and another discrete component.

### BRIEF DESCRIPTION OF THE DRAWINGS

FIG. 1 is a schematic flowchart of a data processing method according to an embodiment of this application;

FIG. 2a is a schematic diagram of a structure of an ear according to an embodiment of this application;

FIG. 2b is a schematic diagram including two sub-schematic diagrams of locations of audio collection apparatuses according to an embodiment of this application;

FIG. 3 is a schematic flowchart of a data processing method according to an embodiment of this application;

FIG. 4 is a schematic interface diagram of a trigger interface of a “target feature information obtaining procedure” in a data processing method according to an embodiment of this application;

FIG. 5 is a schematic diagram of target feature information in a data processing method according to an embodiment of this application;

FIG. 6 is a schematic interface diagram of obtaining target feature information in a data processing method according to an embodiment of this application;

FIG. 7 is a schematic diagram of feedback signals separately collected when an earbud is in a worn state and a non-worn state in a data processing method according to an embodiment of this application;

FIG. 8 is a schematic diagram of an interface for outputting third prompt information in a data processing method according to an embodiment of this application;

FIG. 9 is a schematic interface diagram of verifying a detection result of a target earbud in a data processing method according to an embodiment of this application;

FIG. 10 is a schematic interface diagram of verifying a detection result of a target earbud in a data processing method according to an embodiment of this application;

FIG. 11 is a schematic diagram of an interface for triggering verification of a first detection result in a data processing method according to an embodiment of this application;

FIG. 12 is a schematic diagram of an interface for triggering verification of a detection result corresponding to a target earbud in a data processing method according to an embodiment of this application;

FIG. 13 is a schematic flowchart of generating a detection result corresponding to a target earbud in a data processing method according to an embodiment of this application;

FIG. 14 is a schematic diagram of a principle of generating a detection result corresponding to a target earbud in a data processing method according to an embodiment of this application;

FIG. 15 is another schematic flowchart of generating a detection result corresponding to a target earbud in a data processing method according to an embodiment of this application;

FIG. 16 is a schematic diagram of determining an orientation of a forward axis corresponding to a target earbud in a data processing method according to an embodiment of this application;

FIG. 17 is a schematic diagram of another principle of generating a detection result corresponding to a target earbud in a data processing method according to an embodiment of this application;

FIG. 18 is a schematic diagram of still another principle of generating a detection result corresponding to a target earbud in a data processing method according to an embodiment of this application;

FIG. 19 is a schematic diagram of a structure of a data processing apparatus according to an embodiment of this application;

FIG. 20 is a schematic diagram of another structure of a data processing apparatus according to an embodiment of this application;

FIG. 21 is a schematic diagram of still another structure of a data processing apparatus according to an embodiment of this application;

FIG. 22 is a schematic diagram of yet another structure of a data processing apparatus according to an embodiment of this application; and

FIG. 23 is a schematic diagram of a structure of an execution device according to an embodiment of this application.

### DETAILED DESCRIPTION OF THE EMBODIMENTS

In the specification, claims, and accompanying drawings of this application, the terms “first”, “second”, and the like are intended to distinguish between similar objects but do not necessarily indicate a specific order or sequence. It should be understood that the terms used in such a way are interchangeable in proper circumstances, which is merely a discrimination manner that is used when objects having a same attribute are described in embodiments of this application. In addition, the terms “include”, “contain”, and any other variants mean to cover the non-exclusive inclusion, so that a process, method, system, product, or device that includes a series of units is not necessarily limited to those units, but may include other units not expressly listed or inherent to such a process, method, system, product, or device.

The following describes embodiments of this application with reference to accompanying drawings. A person of ordinary skill in the art may know that, with development of technologies and emergence of a new scenario, the technical solutions provided in embodiments of this application are also applicable to similar technical problems.

This application may be applied to various application scenarios of a headset. One headset includes two target earbuds. Optionally, shapes of the two target earbuds may be symmetrical. The headset includes but is not limited to an in-ear headset, a semi-in-ear headset, an over-ear headset, an on-ear headset, a headset of another type, or the like. Specifically, in an example, when a user wears the headset to watch a movie, the headset may play stereo sound effect. For example, a train passes by from left to right in a picture, and the two earbuds of the headset cooperate to play the sound effect, to create sound of the train passing by from left to right. If the two earbuds of the headset are worn reversely by the user, the picture does not match the sound, which causes hearing and visual confusion.

In another example, when the user wears the headset to play a game, the headset may play stereo sound effect. For example, in a shooting game, when a non-player role (non-player character, NPC) in the game appears around the user, a location of the NPC relative to a location of the user may be simulated by using the two earbuds of the headset, to enhance immersion of the user. If the two earbuds of the headset are worn reversely by the user, hearing and visual confusion is caused.

In still another example, for example, when a navigation-type application program plays a navigation route to the user by using the headset, a to-be-played audio is “turn right”, that is, the to-be-played audio carries direction information, “turn right” may be played only in an earbud determined as a right channel, to more intuitively navigate the user in an audio form. If the two earbuds of the headset are worn reversely by the user, hearing is inconsistent with content of the played audio, and the user is more confused. It should be noted that application scenarios of embodiments of this application are not enumerated herein.

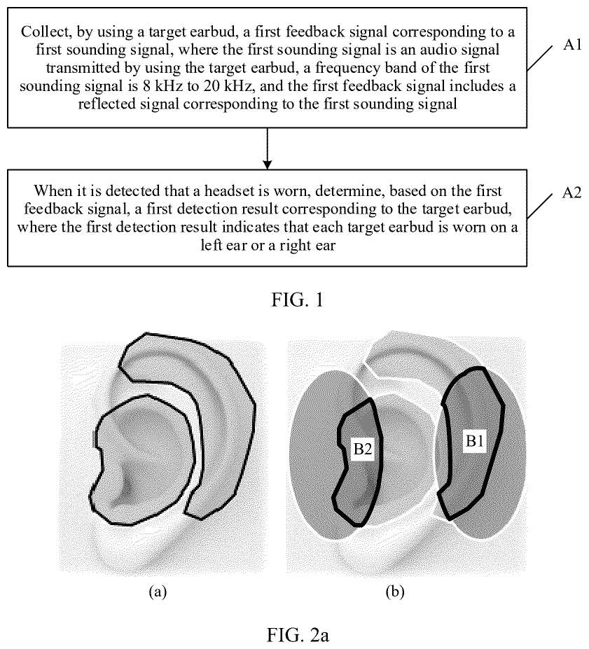

An embodiment of this application provides a data processing method, to detect, based on an actual wearing status of a user, whether each target earbud is worn on the left ear or the right ear of the user in the foregoing application scenarios. In the data processing method, a specific wearing status of each target earbud is automatically detected according to an acoustic principle. Specifically, FIG. 1 is a schematic flowchart of a data processing method according to an embodiment of this application. A1: Collect, by using a target earbud, a first feedback signal corresponding to a first sounding signal, where the first sounding signal is an audio signal transmitted by using the target earbud, a frequency band of the first sounding signal is 8 kHz to 20 kHz, and the first feedback signal includes a reflected signal corresponding to the first sounding signal. A2: When it is detected that the headset is worn, determine, based on the first feedback signal, a first detection result corresponding to the target earbud, where the first detection result indicates that the target earbud is worn on a left ear or a right ear. In embodiments of this application, whether the target earbud is worn on the left ear or the right ear is determined based on an actual wearing status of a user. In other words, the user does not need to wear a headset based on a mark on each earbud. This simplifies an operation of the user, and helps improve customer stickiness in this solution. In addition, an actual wearing status of each target earbud is detected according to an acoustic principle. Because a speaker and a microphone are usually disposed inside the headset, no additional hardware is required, and manufacturing costs are reduced.

An audio sending apparatus and an audio collection apparatus are disposed in each target earbud, to transmit the first sounding signal by using the audio sending apparatus in the target earbud, and collect, by using the audio collection apparatus in the target earbud, the first feedback signal corresponding to the first sounding signal. At least one audio sending apparatus may be disposed in one target earbud, and at least one audio collection apparatus is disposed in one target earbud. The audio sending apparatus may specifically be represented as a speaker or an audio sending apparatus of another type. The audio collection apparatus may specifically be represented as a microphone or an audio collection apparatus of another type. Quantities of speakers and microphones in the target earbud are not limited herein. In subsequent embodiments of this application, only an example in which the audio sending apparatus is specifically represented as a speaker and the audio collection apparatus is specifically represented as a microphone is used for description.

Further, one headset includes two target earbuds, and the two target earbuds may include a first earbud and a second earbud. A first audio collection apparatus is disposed in the first earbud, and a second audio collection apparatus is disposed in the second earbud. The first audio collection apparatus may be disposed in any location in the first earbud, and the second audio collection apparatus may be disposed in any location in the second earbud. Optionally, in a case in which the headset is an over-ear headset or an on-ear headset, because shapes of the two earbuds of the headset are symmetrical, when the headset is worn, if the first audio collection apparatus corresponds to a helix (helix) area of a user, the second audio collection apparatus corresponds to a concha (concha) area of the user; or when the headset is worn, the first audio collection apparatus corresponds to a concha area of a user, and the second audio collection apparatus corresponds to a helix area of the user.

“Corresponding to the helix area of the user” may specifically be in contact with the helix area of the user, or may be suspended above the helix area of the user. Correspondingly, “corresponding to the concha area of the user” may specifically be in contact with the concha area of the user, or may be suspended above the concha area of the user.

Further, after the headset is delivered from a factory, a location of the audio collection apparatus in the earbud is fixed, and the shapes of the two target earbuds of the headset are symmetrical. Therefore, in an implementation, the first audio collection apparatus corresponds to a helix area of the left ear, and the second audio collection apparatus corresponds to a concha area of the right ear; or the second audio collection apparatus corresponds to a helix area of the left ear, and the first audio collection apparatus corresponds to a concha area of the right ear. In other words, regardless of a manner in which the user wears the headset, one audio collection apparatus corresponds to the helix area of the left ear, and the other audio collection apparatus corresponds to the concha area of the right ear.

In another implementation, the first audio collection apparatus corresponds to a concha area of the left ear, and the second audio collection apparatus corresponds to a helix area of the right ear; or the second audio collection apparatus corresponds to a concha area of the left ear, and the first audio collection apparatus corresponds to a helix area of the right ear. In other words, regardless of a manner in which the user wears the headset, one audio collection apparatus corresponds to the concha area of the left ear, and the other audio collection apparatus corresponds to the helix area of the right ear.

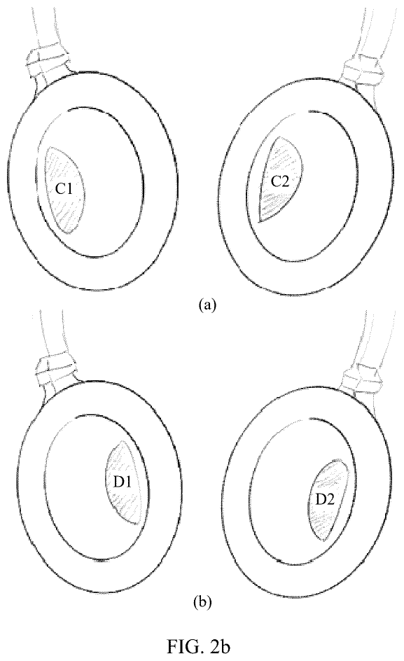

To more intuitively understand this solution, the fixed location of the audio collection apparatus in the target earbud is described with reference to FIG. 2a and FIG. 2b. FIG. 2a is a schematic diagram of a structure of an ear according to an embodiment of this application. FIG. 2a includes two sub-diagrams (a) and (b), and the sub-diagram (a) in FIG. 2a shows a helix area and a concha area of the ear. Refer to the sub-schematic diagram (b) in FIG. 2a. B1 is an area, in the helix area of the user, corresponding to the audio collection apparatus in the target earbud, and B2 is an area, in the concha area of the user, corresponding to the audio collection apparatus in the target earbud.

FIG. 2b is a schematic diagram including two sub-schematic diagrams of locations of audio collection apparatuses according to an embodiment of this application. FIG. 2b includes two sub-schematic diagrams (a) and (b). In the sub-schematic diagram (a) in FIG. 2b, an example in which the audio collection apparatus in one target earbud is disposed in a C1 area of the earbud, and the audio collection apparatus in the other target earbud is disposed in a C2 area of the earbud is used. When the user wears the headset, the audio collection apparatus in one target earbud always corresponds to the helix area of the left ear, the audio collection apparatus in the other target earbud always corresponds to the concha of the right ear.

In the sub-schematic diagram (b) in FIG. 2b, an example in which the audio collection apparatus in one target earbud is disposed in a D1 area of the earbud, and the audio collection apparatus in the other target earbud is disposed in a D2 area of the earbud is used. When the user wears the headset, the audio collection apparatus in one target earbud always corresponds to the concha area of the left ear, the audio collection apparatus in the other target earbud always corresponds to the helix of the right ear. It should be understood that the examples in FIG. 2a and FIG. 2b are merely for ease of understanding this solution, and are not intended to limit this solution. A specific location of the audio collection apparatus in the target earbud needs to be flexibly set based on an actual situation.

In embodiments of this application, because the helix area is an area with largest coverage of the headset, and the concha area is an area with smallest coverage of the headset, first feedback signal is greatly weakened compared with the sent first sounding signal. If the audio collection apparatus corresponds to the concha area of the user, in comparison with the sent first sounding signal, a degree to which the collected first feedback signal is weakened is low, to further amplify a difference between the first feedback signals corresponding to the left ear and the right ear. This helps improve accuracy of a detection result corresponding to the target earbud.

Optionally, a touch sensor may further be disposed in the headset, and a touch operation, for example, a tap operation, a double-tap operation, a sliding operation, or another type of touch operation input by the user on a surface of the headset, input by the user may be received by using the touch sensor. Examples are not enumerated herein. A feedback system may further be configured for the headset, and the headset may provide, in a sound, vibration, or another manner, feedback for the user wearing the headset.

A plurality of sensors may further be disposed in the headset. The plurality of sensors include but are not limited to a motion sensor, an optical sensor, a capacitive sensor, a voltage sensor, an impedance sensor, a photosensitive sensor, a proximity sensor, an image sensor, or another type of sensor. Further, for example, the motion sensor (for example, an accelerometer, a gyroscope, or another type of motion sensor) in the headset may be configured to detect a pose of the headset. For another example, the optical sensor may be configured to detect whether the earbud included in the headset are taken out of a headset case. For another example, the touch sensor may be configured to detect a touch point of a finger on the surface of the headset. Purposes of the plurality of sensors are not enumerated herein.

Before the data processing method according to embodiments of this application is described in detail, a data processing system according to embodiments of this application is first described. The entire data processing system may include a headset and an electronic device communicatively connected to the headset, and the headset includes two earbuds. The electronic device may include an input system, a feedback system, a display, a calculation unit, a storage unit, and a communication unit. For example, the electronic device may specifically be represented as a mobile phone, a tablet computer, a smart television, a VR device, or an electronic device in another form. Examples are not enumerated herein.

In an implementation, the electronic device is configured to detect an actual wearing status of each earbud. In another implementation, the headset detects an actual wearing status of each earbud.

It should be noted that, in the foregoing descriptions, the entire data processing system detects the actual wearing status of each target earbud in an acoustic manner. Embodiments of this application not only provide an acoustic-based manner for detecting an actual wearing status of each target earbud, but also provide another manner for detecting an actual wearing status of each target earbud. The following describes a specific implementation procedure of the data processing method provided in embodiments of this application.

1. Detect, in an acoustic manner, whether the target earbud is worn on the left ear or the right ear of the user

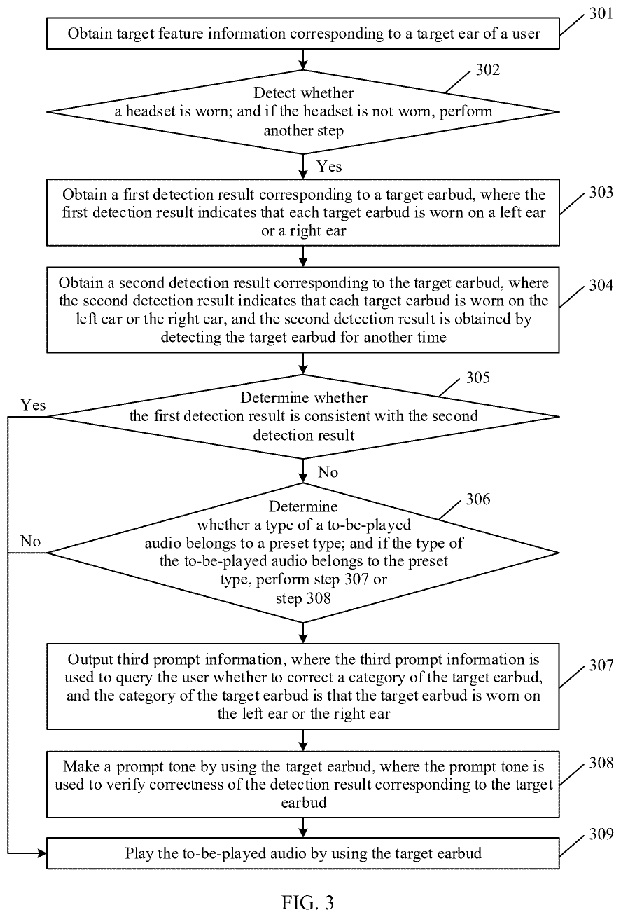

Specifically, FIG. 3 is a schematic flowchart of a data processing method according to an embodiment of this application. The data processing method provided in embodiments of this application may include the following steps.

301: An execution device obtains target feature information corresponding to a target ear of a user.

In some embodiments of this application, the execution device may obtain, in advance, at least one piece of target feature information corresponding to the target ear of the user. The target ear may be a left ear of the user, or may be a right ear of the user. The target feature information corresponding to the target ear may be feature information of a second feedback signal corresponding to the target ear, or may be feature information of a difference between a second feedback signal corresponding to the target ear and a second sounding signal corresponding to the target ear. The second feedback signal includes a reflected signal corresponding to the second sounding signal, and the second sounding signal is an audio signal transmitted by using a target earbud.

Further, the execution device may obtain target feature information corresponding to only the left ear (or the right ear), or may obtain both target feature information corresponding to the left ear and target feature information corresponding to the right ear.

Step 301 is an optional step. The execution device that performs step 301 is a device with a display screen. The execution device may specifically be a headset, or may be another electronic device communicatively connected to a headset. It should be noted that the execution device in embodiments of this application may be a headset, or may be another electronic device communicatively connected to a headset. This is not described in subsequent embodiments again.

The following describes an occasion at which the execution device obtains the target feature information. Specifically, in an implementation, the target feature information corresponding to the target ear of the user may be preconfigured on the execution device.

In another implementation, when the headset is connected to another execution device for the first time, or when the user wears the headset for the first time, a target feature information obtaining procedure may be triggered. The foregoing connection may be a communication connection using a Bluetooth module, a wired connection, or the like. Examples are not enumerated herein.

In another implementation, a trigger button may be disposed on the target earbud, to trigger a target feature information obtaining procedure. In another implementation, because the execution device that performs step 301 is a device with a display screen, a trigger interface for a “target feature information obtaining procedure” may be disposed on the execution device, so that the user may actively enable, through the trigger interface, the target feature information obtaining procedure. It should be noted that the foregoing example of the triggering manner for the “target feature information obtaining procedure” is merely for ease of understanding of this solution. A specific triggering manner or specific triggering manners that are used may be flexibly determined with reference to a product form of an actual product. This is not limited herein.

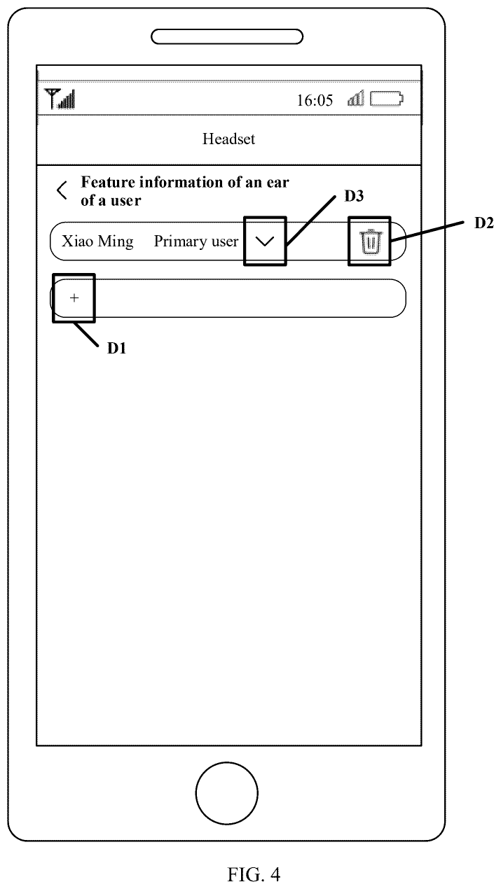

To more intuitively understand this solution, FIG. 4 is a schematic interface diagram of a trigger interface of a “target feature information obtaining procedure” in a data processing method according to an embodiment of this application. In FIG. 4, an example in which the execution device has collected target feature information corresponding to each ear of a user Xiao Ming is used. As shown in the figure, when the user taps D1, step 301 may be triggered, that is, collection of the target feature information corresponding to the target ear of the user is triggered. Because the primary user is an owner of a mobile phone by default, when the user taps D2, an interface for modifying a user attribute may be displayed. When the user taps D3, an operation for deleting the collected target feature information may be triggered. It should be understood that the example in FIG. 4 is merely for ease of understanding this solution, and is not intended to limit this solution.

The following describes a process in which the execution device obtains the target feature information. Specifically, in an implementation, the feedback signal collected by using the target earbud is the reflected signal corresponding to the sounding signal. The execution device may transmit the second sounding signal by using a speaker in one target earbud. The worn target earbud forms a sealed cavity including a cavity on an ear canal (or an ear auricle and an ear canal). After being reflected in the sealed cavity a plurality of times, the second sounding signal may be received by a microphone in the target earbud that transmits the second sounding signal, that is, the execution device collects, by using the microphone in the target earbud that transmits the second sounding signal, the reflected signal (namely, an example of the second feedback signal) corresponding to the second sounding signal. After collecting the second feedback signal corresponding to the second sounding signal, the execution device obtains, according to a principle of an ear transfer function (ear transfer function, ETF), the target feature information corresponding to the target ear of the user.

The second sounding signal is specifically an audio signal at an ultra-high frequency band or an ultrasonic frequency band. For example, a frequency band of the second sounding signal may be 8 kHz to 20 kHz, 16 kHz to 24 kHz, or another frequency band. Examples are not enumerated herein. Optionally, the second sounding signal may specifically be an audio signal that varies at different frequencies, and the second sounding signal has same signal strength at the different frequencies. For example, the second sounding signal may be a linear chirp (chirp) signal or an audio signal of another type. Examples are not enumerated herein.

Further, when the headset is an over-ear headset or an on-ear headset, the execution device may perform processing according to a principle of an ear auricle transfer function (ear auricle transfer function, EATF). Alternatively, when the headset is an in-ear headset, a semi-in-ear headset, or an over-ear headset, the execution device may perform processing according to a principle that an ear transfer function is an ear canal transfer function (ear canal transfer function, ECTF).

In embodiments of this application, a specific type of an ear transfer function used when the headset is in different forms is provided, to extend an application scenario of this solution, and improve flexibility of this solution.

More specifically, the following describes a process in which the execution device obtains the second feedback signal corresponding to the second sounding signal. If the execution device is another electronic device communicatively connected to the headset, that the execution device transmits the second sounding signal by using a speaker in one target earbud may include: The execution device transmits a second instruction to the headset, where the second instruction instructs any earbud (namely, the target earbud) in the headset to transmit the second sounding signal. That the execution device collects, by using the microphone in the target earbud (namely, the target earbud on a same side) that transmits the second sounding signal, the reflected signal corresponding to the second sounding signal may include: The execution device receives the reflected signal that corresponds to the second sounding signal and that is sent by the headset.

If the execution device is a headset, that the execution device transmits the second sounding signal by using a speaker in one target earbud may include: The headset transmits the second sounding signal by using the target earbud. That the execution device receives the reflected signal that corresponds to the second sounding signal and that is sent by the headset may include: The headset collects, by using a microphone in the target earbud on a same side, the reflected signal (namely, the second feedback signal) corresponding to the second sounding signal.

The following describes a process in which the execution device generates, based on the second feedback signal corresponding to the second sounding signal, target feature information corresponding to one target ear. In an implementation, the execution device directly processes, according to the principle of the ear transfer function, the collected second feedback signal, to obtain the target feature information corresponding to the target ear of the user. In other words, the target feature information is specifically feature information of the second reflected signal corresponding to the second sounding signal.

Then, the execution device may preprocess the second reflected signal corresponding to the collected second sounding signal. A preprocessing method includes but is not limited to

Fourier transform (Fourier transform), short-time Fourier transform (short-time Fourier transform, STFT), wavelet transform (wavelet transform), or preprocessing in another form. The execution device obtains any one of the following features of a preprocessed second feedback signal: a frequency domain feature, a time domain feature, a statistical feature, another type of feature, or the like. Optionally, the execution device may further perform optimization processing on the foregoing obtained feature, to obtain the target feature information corresponding to the target ear of the user.

In another implementation, the execution device obtains, according to the principle of the ear transfer function and the difference between the collected second feedback signal and the transmitted second sounding signal, the target feature information corresponding to the target ear of the user. In other words, the target feature information is specifically feature information of the difference between the second reflected signal (namely, an example of the second feedback signal) corresponding to the second sounding signal and the second sounding signal.

Then, the execution device may preprocess the transmitted second sounding signal. A preprocessing method includes but is not limited to Fourier transform, short-time Fourier transform, wavelet transform, or preprocessing in another form. The execution device obtains any one of the following features of a preprocessed second sounding signal: a frequency domain feature, a time domain feature, a statistical feature, another type of feature, or the like. Optionally, the execution device may further perform optimization processing on the obtained feature of the second sounding signal, to obtain target feature information corresponding to the second sounding signal.

The execution device preprocesses the collected second feedback signal, and obtains a feature of a preprocessed second feedback signal. Optionally, the execution device performs optimization processing on the obtained feature of the second feedback signal, to obtain target feature information corresponding to the second feedback signal. For a specific implementation in which the execution device generates the “target feature information corresponding to the second feedback signal”, refer to the specific implementation of generating the “target feature information corresponding to the second sounding signal”. Details are not described herein again. The execution device obtains a difference between the target feature information corresponding to the second feedback signal and the target feature information corresponding to the second sounding signal, to obtain the target feature information corresponding to the target ear of the user.

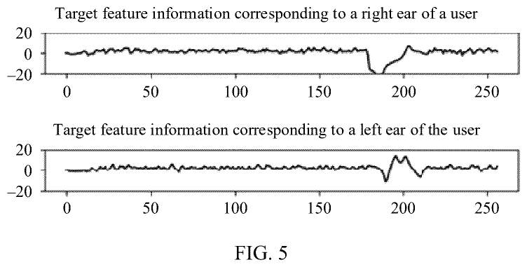

To more intuitively understand this solution, FIG. 5 is a schematic diagram of target feature information in a data processing method according to an embodiment of this application. FIG. 5 uses an example in which the target feature information is the difference between the second reflected signal corresponding to the second sounding signal and the second sounding signal, and the target feature information is a frequency domain feature. FIG. 5 separately shows an example of the target feature information corresponding to the right ear of the user and an example of the target feature information corresponding to the left ear of the user. It can be seen from comparison in FIG. 5 that there is an obvious difference between the target feature information corresponding to the right ear of the user and the target feature information corresponding to the left ear of the user. It should be noted that FIG. 5 is a schematic diagram obtained after visualized processing is performed on the target feature information, and the example in FIG. 5 is merely for ease of understanding this solution, and is not intended to limit this solution.

Further, the execution device needs to actively determine, by the user, whether the target ear is the left ear or the right ear, that is, the user needs to determine whether the target ear wearing the target earbud that transmits the second sounding signal is the left ear or the right ear of the user. In an implementation, the second sounding signal transmitted by using the target earbud is a sound signal that can be heard by the user. After obtaining the target feature information corresponding to the target ear of the user, the execution device may output query information, so that the user determines whether the ear wearing the target earbud that transmits the second sounding signal is the left ear or the right ear. The query information may specifically be represented as a voice, a text box, another form, or the like. Examples are not enumerated herein.

In another implementation, before the second sounding signal is transmitted by using the target earbud, the execution device may prompt the user to interact with the target earbud worn on the left ear (or the right ear) of the user, to trigger the target earbud worn on the left ear (or the right ear) of the user to transmit the second sounding signal. The foregoing interaction may be pressing a physical button on the target earbud, touching a surface of the target earbud, tapping a surface of the target earbud, double tapping a surface of the target earbud, another interaction operation, or the like. This is not limited herein. For example, the foregoing prompt information may be “Touch the earbud worn on the left ear”. For another example, the foregoing prompt information may be “Tap the earbud worn on the right ear”. Examples are not enumerated herein. It should be noted that the manner in which the user determines whether the target ear wearing the target earbud is the left ear or the right ear is merely listed herein for ease of understanding this solution, and is not intended to limit this solution.

Optionally, step 301 may include: The execution device obtains a plurality of pieces of target feature information corresponding to a plurality of wearing angles of the target earbud, where each piece of target feature information includes feature information of a second feedback signal corresponding to one wearing angle of the target earbud.

Further, in an implementation, the plurality of pieces of target feature information corresponding to the plurality of wearing angles of the target earbud worn on the target ear may be preconfigured on the execution device.

In an implementation, the plurality of pieces of target feature information are collected by using the headset. In a process in which the execution device obtains the plurality of pieces of target feature information by using the headset, because the user may obtain different second feedback signals when wearing the target earbud at different angles, the execution device may further prompt the user to rotate the target earbud. After the user rotates the target earbud, the execution device performs the target feature information obtaining operation for another time, and repeats the foregoing step for at least one time, to obtain the plurality of pieces of target feature information corresponding to the target ear of the user, each of the plurality of pieces of target feature information corresponds to one wearing angle.

Further, in a case, the execution device may obtain a plurality of groups of target feature information through collection by using the headset, where each group of target feature information includes the plurality of pieces of target feature information corresponding to the plurality of wearing angles of the target earbud worn on the target ear; and send the plurality of groups of target feature information to a server. After obtaining the plurality of groups of target feature information, the server obtains, from each group of target feature information, one piece of target feature information corresponding to one determined wearing angle, to obtain, from the plurality of groups of target feature information, a plurality of pieces of target feature information corresponding to the determined wearing angle; and performs statistical processing on the plurality of pieces of target feature information corresponding to the determined wearing angle, to obtain one piece of target feature information corresponding to the determined wearing angle. The server performs the foregoing operation for each wearing angle, to obtain, based on the plurality of groups of target feature information, the plurality of pieces of target feature information one-to-one corresponding to the plurality of wearing angles of the target earbud, and sends, to the execution device, the plurality of pieces of target feature information one-to-one corresponding to the plurality of wearing angles of the target earbud.

In another case, the execution device may directly store, locally, the plurality of pieces of collected target feature information one-to-one corresponding to the plurality of wearing angles of the target earbud.

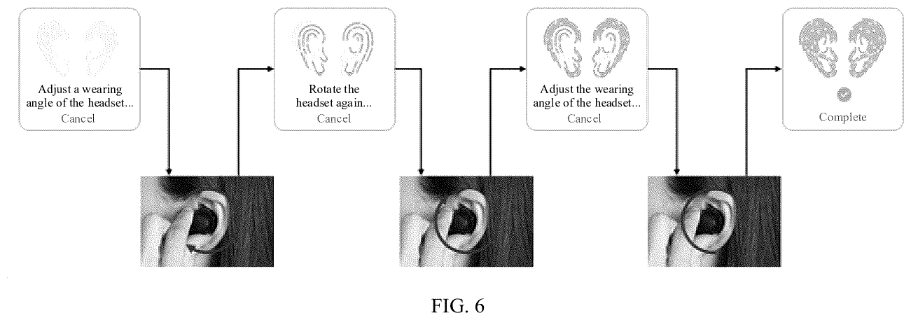

To more intuitively understand this solution, FIG. 6 is a schematic interface diagram of obtaining target feature information in a data processing method according to an embodiment of this application. In FIG. 6, an example of prompting the user to rotate the target earbud in a form of text is used. In FIG. 6, an example in which obtaining the target feature information corresponding to the target ear of the user is completed after the user rotates the earbud for three times is used. In other words, in FIG. 6, four pieces of target feature information corresponding to the target ear of the user are obtained. The four pieces of target feature information respectively correspond to four wearing angles. It should be understood that the example in FIG. 6 is merely for ease of understanding, and is not intended to limit this solution.

It should be noted that step 301 is an optional step. If step 301 is performed, an execution sequence of step 301 is not limited in embodiments of this application, and step 301 may be performed before or after any step, or may be performed when the user uses the headset for the first time. A specific implementation may be flexibly set based on an actual application scenario.

Optionally, after obtaining the target feature information corresponding to the target ear of the user, the execution device may further use the obtained target feature information corresponding to the target ear as information for verifying an identity of the user, that is, a function of the “target feature information corresponding to the target ear” is similar to that of fingerprint information.

Further, optionally, if the execution device collects at least two pieces of target feature information corresponding to each ear of the user, a primary user of at least two users may be used as an owner of the execution device, so that the target feature information corresponding to each ear of the primary user is used as information for verifying an identity of the primary user.

302: The execution device detects whether the headset is worn; and if the headset is worn, performs step 303; or if the headset is not worn, performs another step.

In some embodiments of this application, the execution device may perform step 302 in any one or more of the following scenarios: when the target earbud is picked up, each time the target earbud is taken out of the case, after the target earbud is removed from the ear, or in another scenario. The execution device may further detect whether each target earbud of the headset is worn. If it is detected that the target earbud is in a worn state, step 303 is performed.

If the execution device detects that the target earbud is not worn, the execution device may perform step 302 again, to continue to detect whether the target earbud is worn. Optionally, step 302 may be stopped when a quantity of detection times reaches a preset quantity of times, where the preset quantity of times may be 1, 2, 3, another value, or the like. Alternatively, step 302 may be stopped when duration of the foregoing detection reaches preset duration, where the preset duration may be 2 minutes, 3 minutes, 5 minutes, other duration, or the like. Alternatively, step 302 may be continuously performed until it is detected that the user wears the target earbud.

Specifically, when the execution device detects any one or more of the following cases, it is considered that it is detected that the headset is worn: it is detected that an application program of a preset type is opened, it is detected that a screen of an electronic device communicatively connected to the headset is on, or it is detected that the target earbud is placed on the ear. The application program of the preset type may be a video-type application program, a game-type application program, a navigation-type application program, another application program that may generate a stereo audio, or the like.

In embodiments of this application, a plurality of cases in which a headset is detected to be worn are provided, to extend an application scenario of this solution. In addition, when the application program of the preset type is opened, and it is detected that the screen of the electronic device communicatively connected to the headset is on or that the target earbud is placed on the ear, an audio is not played by using the headset, that is, an actual wearing status of the earbud is detected before the audio is actually played by using the headset. This helps assist the headset in correctly playing an audio, to further improve customer stickiness in this solution.

More specifically, the following describes a principle that the execution device detects whether the target earbud is placed on the ear. After transmitting the sounding signal by using the speaker in the target earbud, the execution device collects, by using the microphone (namely, the microphone in the earbud on the same side) in the target earbud that transmits the sounding signal, the feedback signal corresponding to the sounding signal. When the target earbud is not worn, corresponding space of the target earbud is open, and the microphone in the target earbud collects a small quantity of feedback signals (denoted as a “signal A” for ease of description). When the target earbud is worn by the user, a cavity of the target earbud and an ear canal (and/or an ear auricle) of the user form a sealed cavity. A sounding signal is reflected by the ear a plurality of times, and the microphone in the target earbud can collect a large quantity of feedback signals (denoted as a “signal B” for ease of description). First feature information of the signal A differs greatly from first feature information of the signal B. Therefore, the first feature information of the signal A is compared with the first feature information of the signal B, to distinguish whether the target earbud is worn by the user.

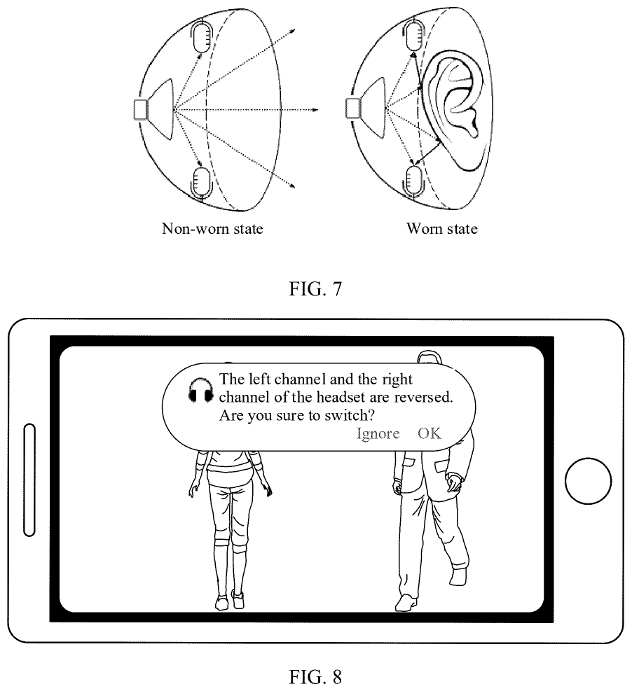

To more intuitively understand this solution, FIG. 7 is a schematic diagram of feedback signals separately collected when an earbud is in a worn state and a non-worn state in a data processing method according to an embodiment of this application. As shown in FIG. 7, when the earbud is in the non-worn state, after the earbud transmits the sounding signal by using the speaker, the microphone in the earbud on the same side collects only a small quantity of feedback signals (namely, the “signal A”). When the earbud is in the worn state, after the earbud transmits the sounding signal by using the speaker, the sounding signal is reflected by the ear, and the microphone in the earbud on the same side can collect a large quantity of feedback signals (namely, the “signal B”), so that the first feature information of the signal A differs greatly from the first feature information of the signal B. It should be understood that the example in FIG. 7 is merely for ease of understanding this solution, and is not intended to limit this solution.

The following describes a process in which the execution device detects whether the target earbud is worn. A first classification model on which a training operation is performed may be configured on the execution device. The execution device may transmit a first sounding signal by using the speaker in the target earbud (namely, any earbud of the headset), and collect, by using the microphone in the target earbud, a first feedback signal corresponding to the first sounding signal. In this step, the first feedback signal is specifically represented as a first reflected signal corresponding to the first sounding signal. For a process in which the execution device obtains the first feedback signal corresponding to the first sounding signal, refer to the descriptions of the “process in which the execution device obtains the second feedback signal corresponding to the second sounding signal” in step 301. Details are not described herein again.

The execution device obtains first feature information corresponding to the first feedback signal. A concept of the “first feature information” is similar to a concept of the “target feature information”. The first feature information may be feature information of the first feedback signal corresponding to the first sounding signal, or feature information of a difference between the first feedback signal corresponding to the first sounding signal and the first sounding signal. For a specific implementation in which the execution device generates, based on the first feedback signal corresponding to the first sounding signal, the first feature information corresponding to the first feedback signal, refer to the descriptions about generating the “target feature information” in step 301. Details are not described herein again.

The execution device inputs, to the first classification model, the first feature information corresponding to the first feedback signal, to obtain a first predicted category output by the first classification model, where the first predicted category indicates whether the target earbud is worn. Optionally, if the execution device collects, by using the target earbud that transmits the sounding signal, the feedback signal corresponding to the sounding signal, and determines, based on the collected feedback signal, whether the target earbud is worn on the left ear or the right ear of the user, the first predicted category may further indicate whether the target earbud is worn on the left ear or the right ear.

The first classification model may be a non-neural network model, a neural network used for classification, or the like. This is not limited herein. For example, the first classification model may specifically use a k-nearest neighbor (k-nearest neighbor, KNN) model, a linear support vector machine (linear support vector machine, linear SVM), a Gaussian process (Gaussian process) model, a decision tree (decision tree) model, a multi-layer perceptron (multi-layer perceptron, MLP) model, or another type of first classification model. This is not limited herein.

The following describes a training process of the first classification model. A first training data set may be configured on a training device, and the first training data set includes a plurality of pieces of first training data and a correct label corresponding to each piece of first training data. If the execution device collects, by using the target earbud that transmits the sounding signal, the reflected signal (namely, an example of the feedback signal) corresponding to the sounding signal, and further determines, based on the collected feedback signal, whether the target earbud is worn on the left ear or the right ear of the user, the correct label is any one of the following three: not worn, worn on the left ear, or worn on the right ear, and the first training data may be any one of the following three: first feature information of a feedback signal (corresponding to the sounding signal) collected when the target earbud is in the non-worn state, first feature information of a reflected signal collected when the target earbud is worn on the left ear, and first feature information of a reflected signal collected when the target earbud is worn on the right ear.

The training device inputs the first training data into the first classification model, to obtain the first predicted category output by the first classification model; generates a function value of a first loss function based on the first predicted category and the correct label that correspond to the first training data; and reversely updates a parameter of the first classification model based on the function value of the first loss function. The training device repeatedly performs the foregoing operations, to implement iterative training on the first classification model until a preset condition is met, so as to obtain the first classification model on which the training operation is performed. The first loss function indicates a similarity between the first predicted category and the correct label that correspond to the first training data. The preset condition may be that a quantity of training times reaches a preset quantity of times, or the first loss function reaches a convergence condition.

303: The execution device obtains a first detection result corresponding to the target earbud, where the first detection result indicates that each target earbud is worn on the left ear or the right ear.

In embodiments of this application, after detecting that the headset is worn, the execution device may generate the first detection result corresponding to each target earbud of the headset, where the first detection result indicates that each target earbud is worn on the left ear or the right ear.

Specifically, step 301 is an optional step. In an implementation, the execution device generates the first detection result by using the first classification model, and collects, by using the earbud on the same side, the first feedback signal corresponding to the first sounding signal. In other words, the first feedback signal corresponding to the first sounding signal is the reflected signal corresponding to the first sounding signal, and step 301 does not need to be performed. The first classification model on which the training operation is performed may be configured on the execution device. The first detection result is the first predicted category generated in step 302. For a specific generation manner of the first predicted category and a specific training solution of the first classification model, refer to the descriptions in step 302. Details are not described herein again.

In another implementation, the execution device performs step 301. In other words, the execution device obtains, by using step 301, at least one piece of target feature information corresponding to the left ear of the user and at least one piece of target feature information corresponding to the right ear of the user. If the execution device collects, by using the earbud on the same side, the second feedback signal corresponding to the second sounding signal in step 301, the execution device may transmit the first sounding signal by using the speaker in the target earbud (namely, any earbud of the headset), and collect, by using the microphone in the target earbud (namely, the target earbud on the same side), the first feedback signal corresponding to the first sounding signal, to obtain the first feature information corresponding to the first feedback signal in step 303. The execution device separately calculates a similarity between the obtained first feature information corresponding to the first feedback signal and the at least one piece of target feature information corresponding to the left ear of the user and a similarity between the obtained first feature information and the at least one piece of target feature information corresponding to the right ear of the user, to determine whether the target earbud is worn on the left ear of the user or the right ear of the user.

Optionally, if the plurality of pieces of target feature information corresponding to the plurality of wearing angles of the target earbud are configured on the execution device, and each piece of target feature information includes feature information of a second feedback signal corresponding to one wearing angle of the target earbud, the execution device may determine the first detection result based on the first feedback signal and the plurality of pieces of target feature information in step 303.

Specifically, in an implementation, after detecting that the headset is worn, the execution device may use an inertial measurement unit (inertial measurement unit, IMU) disposed on the target earbud to obtain the target wearing angle at which the target earbud reflects the first sounding signal, that is, the target wearing angle corresponding to the first feedback signal is obtained. The target wearing angle is a wearing angle, of the target earbud, at which the first feedback signal is collected.

The execution device obtains, from the plurality of pieces of target feature information corresponding to the plurality of wearing angles of the target earbud, a group of determined target feature information corresponding to the target wearing angle. The group of determined target feature information indicates the feature information of the second feedback signal obtained when the target earbud is at the target wearing angle, and may include the feature information of the second feedback signal obtained when the earbud on the left ear is worn at the target wearing angle, and the feature information of the second feedback signal obtained when the earbud on the right ear is worn at the target wearing angle.

The execution device calculates, based on the first feature information corresponding to the first feedback signal, a similarity between the first feature information and the feature information of the feedback signal obtained when the earbud on the left ear is worn at the target wearing angle, and a similarity between the first feature information and the feature information of the feedback signal obtained when the earbud on the right ear is worn at the target wearing angle, to determine the first detection result corresponding to the target earbud.

In another implementation, the execution device may directly calculate a similarity between the first feature information and each of the plurality of groups of target feature information, to determine the first detection result corresponding to the target earbud.

In embodiments of this application, the plurality of pieces of target feature information corresponding to the plurality of wearing angles of the target earbud may further be obtained, and each piece of target feature information includes the feature information of the second feedback signal corresponding to one wearing angle of the target earbud. Further, the first detection result is obtained based on the first feedback signal and the plurality of pieces of target feature information corresponding to the plurality of wearing angles, to ensure that an accurate detection result can be obtained regardless of a wearing angle of the target earbud. This helps further improve accuracy of a finally obtained detection result.

The following describes an occasion at which the execution device performs step 303. Because step 302 is an optional step, if step 302 is not performed, in an implementation, each target earbud of the headset may detect, by using a sensor in the target earbud, whether the target earbud is worn. When the target earbud detects that the target earbud is worn, step 303 may be triggered to be performed. In another implementation, each target earbud of the headset may detect, by using a motion sensor, whether the target earbud is picked up. When the target earbud is picked up, step 303 may be triggered to be performed.

In another implementation, because an in-ear headset or an over-ear headset is usually provided with a case, when the headset is not worn, the headset is usually placed in the case for charging. If step 302 is not performed, a trigger signal in step 303 may alternatively be that it is detected that the headset is taken out of the case.

If step 302 is performed, in an implementation, after it is detected that the target earbud is worn in step 302, step 303 may be triggered to be performed. It should be noted that if step 302 is performed, an execution sequence of step 302 may not be limited in embodiments of this application. In other words, after the user wears the target earbud, step 302 may further be performed. After the user wears the target earbud, if it is detected that the target earbud is not worn, audio playback by using the target earbud may be paused.

With reference to the foregoing descriptions, it can be learned that when the first feedback signal includes the reflected signal corresponding to the first sounding signal, that is, the execution device collects the first sounding signal by using the target earbud that sends the first sounding signal, and the user wears only one target earbud, the execution device may also obtain the first feedback signal corresponding to the first sounding signal, and determine, based on the first feedback signal, whether the worn target earbud is worn on the left ear or the right ear.

Optionally, when the first feedback signal includes the reflected signal corresponding to the first sounding signal, that is, the first feedback signal is collected by using the target earbud that transmits the first sounding signal, and the execution device detects that the target earbud (namely, any earbud of the headset) is worn, the execution device may determine, based on signal strength of the first feedback signal, target wearing information corresponding to the target earbud that collects the first feedback signal. The target wearing information indicates wearing tightness of the target earbud. It should be noted that if two target earbuds of the headset perform the foregoing operation, wearing tightness of each target earbud may be obtained.

Further, a preset strength value may be configured on the execution device. When the signal strength of the first feedback signal is greater than the preset strength value, the obtained target wearing information indicates that the target earbud is “tightly worn”. When the signal strength of the first feedback signal is less than the preset strength value, the obtained target wearing information indicates that the target earbud is “loosely worn”.

In embodiments of this application, not only actual wearing statuses of the two earbuds can be detected based on the acoustic signal, but also wearing tightness of the earbuds can be detected, to provide a more delicate service for the user. This further helps improve customer stickiness in this solution.

304: The execution device obtaining a second detection result corresponding to the target earbud, where the second detection result indicates that each target earbud is worn on the left ear or the right ear, and the second detection result is obtained by detecting the target earbud for another time.

In some embodiments of this application, the execution device may further detect the target earbud for another time, to obtain the second detection result corresponding to the target earbud, where the second detection result indicates that each target earbud is worn on the left ear or the right ear. For a specific implementation of the detection, refer to descriptions in step 303. Details are not described herein.

305: The execution device determines whether the first detection result is consistent with the second detection result; and if the first detection result is inconsistent with the second detection result, performs step 306; or if the first detection result is consistent with the second detection result, performs step 309.

306: The execution device determines whether a type of a to-be-played audio belongs to a preset type; and if the type of the to-be-played audio belongs to the preset type, performs step 307 or step 308; or if the type of the to-be-played audio does not belong to the preset type, performs step 309.

In embodiments of this application, step 304 and step 305 are optional steps. If step 304 and step 305 are performed, when it is determined, by using step 305, that the first detection result is inconsistent with the second detection result, the execution device may further obtain the type of the to-be-played audio, where the to-be-played audio is an audio that needs to be played by using the target earbud; determine whether the type of the to-be-played audio belongs to the preset type; and if the type of the to-be-played audio belongs to the preset type, perform step 307.

If step 304 and step 305 are not performed, step 306 may alternatively be directly performed after step 303 is performed. In other words, after obtaining, by using step 303, the first detection result corresponding to each target earbud, the execution device may directly determine whether the type of the to-be-played audio belongs to the preset type, and if the type of the to-be-played audio belongs to the preset type, perform step 308.

The preset type includes any one or a combination of the following: a stereo audio, an audio from a video-type application program, an audio from a game-type application program, an audio carrying direction information, another audio with a difference between a left channel and a right channel, or the like. For further understanding of the audio, refer to the examples in the foregoing application scenarios. Details are not described herein.

Optionally, the preset type may not include any one or a combination of the following: no audio output, an audio marked as a mono audio, a voice call, an audio marked as a stereo audio with no difference between a left channel and a right channel, another audio with no difference between a left channel and a right channel, or the like. Examples are not enumerated herein. Further, for the “audio marked as a stereo audio with no difference between a left channel and a right channel”, the execution device needs to separately truncate audios of two channels from the audio marked as a stereo audio, to compare whether the audios are consistent. If the audios are consistent, it is proved that the audio is marked as a stereo audio but has no difference between the left channel and the right channel.

307: The execution device outputs third prompt information, where the third prompt information is used to query the user whether to correct a category of the target earbud, and the category of the target earbud is that the target earbud is worn on the left ear or the right ear.

In embodiments of this application, step 306 is an optional step. If step 306 is performed, step 307 is performed when the execution device determines that the first detection result is inconsistent with the second detection result and the type of the to-be-played audio belongs to the preset type. In other words, the execution device may output the third prompt information. The third prompt information is used to query the user whether to correct the category of the target earbud, and the category of the target earbud is that the target earbud is worn on the left ear or the right ear. “Correcting the category of the target earbud” means changing the category of the earbud determined to be worn on the left ear to be worn on the right ear, and changing the category of the earbud determined to be worn on the right ear to be worn on the left ear.

If step 306 is not performed, step 307 may be directly performed when the execution device determines that the first detection result is inconsistent with the second detection result. In other words, the execution device may output the third prompt information.

Specifically, the execution device may output the third prompt information by using a text box, sound, another form, or the like. For example, when a video is being played on the execution device, and the execution device determines that the second detection result is inconsistent with the first detection result, the execution device may output the third prompt information by using the text box. For example, content in the third prompt information may specifically be “Are you sure to switch the left channel and the right channel of the headset”, “The left channel and the right channel are reversed. Are you sure to switch”, and the like, to query the user whether to correct the category of the target earbud. Specific content of the third prompt information is not enumerated herein.

To more intuitively understand this solution, FIG. 8 is a schematic interface diagram of outputting third prompt information in a data processing method according to an embodiment of this application. FIG. 8 is described by using an example of outputting the third prompt information in a form of a text box. It should be understood that the example in FIG. 8 is merely for ease of understanding the solution, and is not intended to limit the solution.

In embodiments of this application, the target earbud is detected for another time, to obtain the second detection result corresponding to the target earbud. When the second detection result is inconsistent with the first detection result, it is determined again that the type of the to-be-played audio belongs to the preset type. Only when the type of the to-be-played audio belongs to the preset type, the third indication information is output, to prompt the user to correct the category of the target earbud. In the foregoing manner, accuracy of a finally determined wearing status of each earbud can be improved. In addition, the user corrects the detection result only when the type of the to-be-played audio belongs to the preset type, to reduce unnecessary disturbance to the user, and help improve customer stickiness in this solution.

In embodiments of this application, several specific types of preset types that need to be corrected by the user are provided, to improve implementation flexibility of this solution, and extend an application scenario of this solution. In addition, for several types of audios: a stereo audio, an audio from a video-type application program, an audio from a game-type application program, and an audio carrying direction information, if a wearing status, determined by the execution device, of each target earbud is inconsistent with an actual wearing status of the user, user experience is usually greatly affected. For example, when the to-be-played audio is an audio from a video-type application program or a game-type application program, if the determined wearing status of each target earbud is inconsistent with the actual wearing status of the user, a picture seen by the user cannot correctly match sound heard by the user. For another example, when the to-be-played audio is an audio carrying direction information, if the determined wearing status of each target earbud is inconsistent with the actual wearing status of the user, a playing direction of the to-be-played audio cannot correctly match content in the to-be-played audio. When the to-be-played audio is a preset audio, serious confusion is caused to the user. Therefore, in these cases, it is more necessary to ensure consistency between the determined wearing status of each target earbud and the actual wearing status of the user, to provide good use experience for the user.

308: The execution device makes a prompt tone by using the target earbud, where the prompt tone is used to verify correctness of the detection result corresponding to the target earbud.

In embodiments of this application, the execution device may further send the prompt tone by using at least one of the two earbuds. The prompt tone is used to verify correctness of the first detection result/second detection result corresponding to the target earbud. If it is found that the first detection result/second detection result corresponding to the target earbud is incorrect, the user may correct the category of the target earbud, that is, changing the earbud determined to be worn on the left ear to be worn on the right ear, and changing the earbud determined to be worn on the right ear to be worn on the left ear.

The following describes a specific implementation of making the prompt tone by using the target earbud. In an implementation, the two target earbuds include a first earbud and a second earbud, the first earbud is determined to be worn in a first direction, and the second earbud is determined to be worn in a second direction. Step 308 may include: The execution device makes a first prompt tone by using the first earbud, and makes a second prompt tone by using the second earbud.

If the first direction corresponds to the left ear, the second direction corresponds to the right ear. If the first direction corresponds to the right ear, the second direction corresponds to the left ear. The first prompt tone and the second prompt tone may both be monophonic notes. Alternatively, both the first prompt tone and the second prompt tone may be chords including a plurality of notes. Alternatively, the first prompt tone may be a monophonic note, and the second prompt tone may be a chord including a plurality of notes. Further, the first prompt tone and the second prompt tone may be consistent or different in terms of a pitch, a timbre, and the like. Setting of the first prompt tone and the second prompt tone may be flexibly determined with reference to an actual situation. This is not limited herein.

Specifically, if the execution device is an electronic device connected to the headset, step 308 may include: The execution device sends a third instruction to at least one target earbud, where the third instruction instructs the target earbud to make a prompt tone. If the execution device is a headset, step 308 may include: The headset makes a prompt tone by using at least one target earbud.

More specifically, in an implementation, the execution device may first keep the second earbud not making sound, and make the first prompt tone by using the first earbud; and then keep the first earbud not making sound, and make the second prompt tone by using the second earbud.

In another implementation, the execution device may make sound by using both the first earbud and the second earbud, but a volume of the first prompt tone is far higher than a volume of the second prompt tone; and then make sound by using both the first earbud and the second earbud, but a volume of the second prompt tone is far higher than a volume of the first prompt tone.

Optionally, step 308 may include: The execution device outputs first prompt information through a first display interface when making a first prompt tone by using the first earbud, where the first prompt information indicates whether the first direction corresponds to the left ear or the right ear; and outputs second prompt information through the first display interface when making a second prompt tone by using the second earbud, where the second prompt information indicates whether the second direction corresponds to the left ear or the right ear. In the foregoing manner, the user may directly determine, by using the prompt information displayed on the display interface and the heard prompt tone, whether the wearing status (namely, the detection result corresponding to each target earbud) of each target earbud detected by the execution device is correct. This reduces difficulty in a process of verifying a detection result corresponding to each target earbud, does not increase additional cognitive burden of the user, facilitates the user to develop a new use habit, and helps improve customer stickiness in this solution.

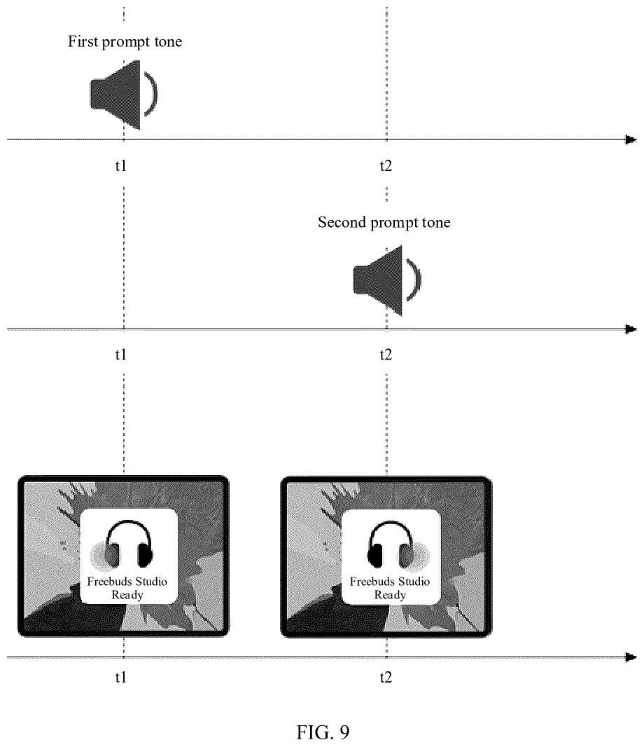

To more intuitively understand this solution, FIG. 9 is a schematic interface diagram of verifying a detection result of a target earbud in a data processing method according to an embodiment of this application. In FIG. 9, an example in which the first detection result of the target earbud is verified, the first direction corresponds to the left ear of the user, and the second direction corresponds to the right ear of the user is used. As shown in FIG. 9, at a moment t1, the execution device makes the first prompt tone by using the first earbud, and does not make sound by using the second earbud. At the same time, the execution device outputs the first prompt information through the first display interface, where the first prompt information is used to prompt the user that the earbud that currently makes the first prompt tone is the earbud determined to be worn on the left ear.

At a moment t2, the execution device makes the second prompt tone by using the second earbud, and does not make sound by using the first earbud. At the same time, the execution device outputs the second prompt information through the first display interface, where the second prompt information is used to prompt the user that the earbud that currently makes the second prompt tone is the earbud determined to be worn on the right ear. It should be understood that the example in FIG. 9 is merely for ease of understanding this solution, and is not intended to limit this solution.

Further, optionally, the execution device may alternatively display a first icon through the first display interface, obtain, by using the first icon, a first operation input by the user, and trigger correction of the category corresponding to the target earbud in response to the obtained first operation.

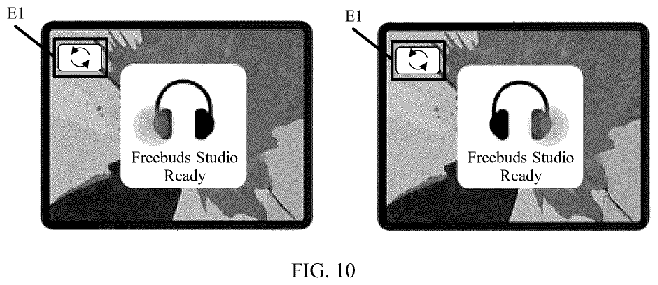

To more intuitively understand this solution, FIG. 10 is a schematic interface diagram of verifying a detection result of a target earbud in a data processing method according to an embodiment of this application. An icon to which E1 points is the first icon. In a process of verifying the detection result of the target earbud, the user may input the first operation at any time by using the first icon, to trigger correction of the category of the target earbud. It should be understood that the example in FIG. 10 is merely for ease of understanding this solution, and is not intended to limit this solution.

In another implementation, the two target earbuds include the first earbud and the second earbud, the first earbud is determined to be worn in a first direction, and the second earbud is determined to be worn in a second direction. Step 308 may include: The execution device obtains, from the first earbud and the second earbud, the earbud determined to be worn in a preset direction, and makes a prompt tone only by using the earbud determined to be worn in the preset direction. The preset direction may be the left ear of the user, or may be the right ear of the user.

In embodiments of this application, the prompt tone is made only in the preset direction (namely, the left ear or the right ear of the user). In other words, if the prompt tone is made only by using the target earbud determined to be worn on the left ear, the user needs to determine whether the target earbud that makes the prompt tone is worn on the left ear. Alternatively, if the prompt tone is made only by using the target earbud determined to be worn on the right ear, the user needs to determine whether the target earbud that makes the prompt tone is worn on the right ear. This provides a new manner of verifying a detection result of the target earbud, and improves implementation flexibility of this solution.

The following describes an occasion at which step 308 is triggered. In an implementation, step 308 may be performed after step 303, that is, after performing step 303, the execution device may directly perform step 308, to trigger, by using step 308, the user to verify the first detection result generated in step 303.

Optionally, after performing step 303, the execution device may be triggered to output first indication information through a second display interface, where the first indication information is used to notify the user that the execution device has completed an operation of detecting the wearing status of each target earbud. A second icon may alternatively be shown on the second display interface. The user may input a second operation by using the second icon, and the execution device triggers execution of step 308 in response to the obtained second operation. For example, the second operation may be represented as a tap operation, a drag operation, or another operation on the second icon. Examples are not enumerated herein.

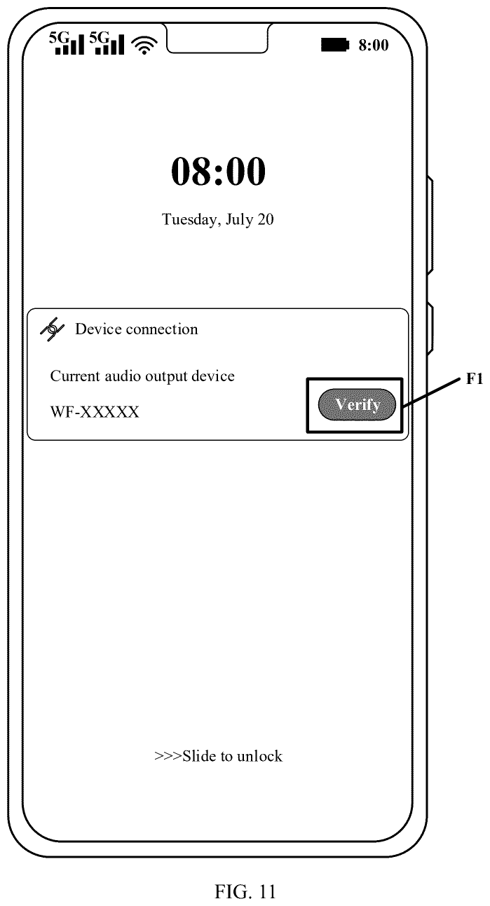

To more intuitively understand this solution, FIG. 11 is a schematic interface diagram of triggering verification of a first detection result in a data processing method according to an embodiment of this application. In FIG. 11, an example in which the second display interface is a lock screen interface is used. After performing step 303, that is, after generating the first detection result corresponding to each target earbud, the execution device may output the first indication information in a form of a pop-up box. An icon to which F1 points is the second icon. The user may input the second operation by using the second icon, and the execution device triggers execution of step 308 in response to the obtained second operation. It should be understood that the example in FIG. 11 is merely for ease of understanding this solution, and is not intended to limit this solution.

In another implementation, step 308 may alternatively be performed after step 307. When the execution device outputs the third prompt information through a third display interface, a third icon may alternatively be displayed on the third display interface, and the user may input a third operation by using the third icon. In response to the obtained third operation, the execution device triggers execution of step 308, to verify the generated first detection result/second detection result by using step 308.

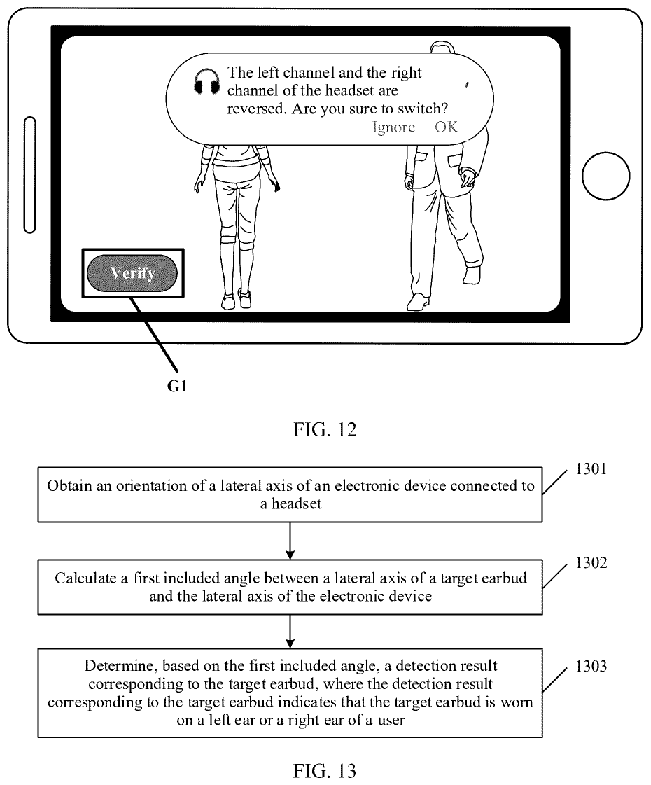

To more intuitively understand this solution, FIG. 12 is a schematic interface diagram of triggering verification of a detection result corresponding to a target earbud in a data processing method according to an embodiment of this application. In FIG. 12, an example of playing an audio of a video application program is used. When determining that the second detection result is inconsistent with the first detection result and the to-be-played audio belongs to the preset audio, the execution device outputs third prompt information through the third display interface. The third prompt information is output through the third display interface, and the third icon (namely, an icon to which G1 points) may alternatively be displayed on the third display interface. The user may input a third operation by using the third icon. The execution device triggers execution of step 308 in response to the obtained third operation. It should be understood that the example in FIG. 12 is merely for ease of understanding of this solution, and is not intended to limit this solution.

In another implementation, step 308 may be triggered to be performed after step 305, that is, when the execution device determines that the first detection result is inconsistent with the second detection result, step 308 may directly be triggered to be performed, to trigger verification of the generated first detection result/second detection result by using step 308.

In another implementation, if step 304 and step 305 are not performed, step 308 may alternatively be directly performed after step 306 is performed. In other words, after obtaining, by using step 303, the first detection result corresponding to each target earbud, the execution device may directly determine whether the type of the to-be-played audio belongs to the preset type, and step 308 is triggered to be performed when the type of the to-be-played audio belongs to the preset type, to verify the generated first detection result by using step 308.

In embodiments of this application, after the actual wearing status of each earbud is detected, at least one target earbud is further used to make the prompt tone, to verify a predicted first detection result. This ensures that a predicted wearing status of each earbud is consistent with the actual wearing status, to further improve customer stickiness in this solution.

309: The execution device plays the to-be-played audio by using the target earbud.

In this embodiment of this application, in one case, step 309 may be directly performed after step 303, that is, after generating the first detection result corresponding to each target earbud, the execution device may directly play, based on the first detection result corresponding to each target earbud, the to-be-played audio by using the two target earbuds of the headset. Specifically, if the to-be-played audio is a stereo audio, the left-channel audio in the to-be-played audio is played by using the target earbud that is determined to be worn on the left ear, and the right-channel audio in the to-be-played audio is played by using the target earbud that is determined to be worn on the right ear.

In another case, step 309 is performed after step 306. In other words, when the first detection result is inconsistent with the second detection result, and the type of the to-be-played audio does not belong to the preset type, because the type of the to-be-played audio does not belong to the preset type, if the execution device has started to play the to-be-played audio based on the first detection result after performing step 303, the execution device may no longer switch a playing channel of the to-be-played audio. If the execution device has not played the to-be-played audio, the execution device may play the to-be-played audio based on the first detection result or the second detection result.

In another case, if step 309 is performed after step 307, the execution device determines, in response to an operation of the user, that the category of the target earbud needs to be corrected, that is, the earbud used to play the left-channel audio needs to be updated to play the right-channel audio, and the earbud used to play the right-channel audio needs to be updated to play the left-channel audio.

More specifically, in an implementation, the execution device may switch the left channel and the right channel at a sound source end (namely, at an execution device end), that is, the execution device may exchange left and right channels of an original to-be-played audio, and transmit a processed to-be-played audio to a headset end device.

In another implementation, the execution device may implement switching between the left channel and the right channel at a headset end. Further, if the headset is a wired headset that receives an analog signal, the received analog signal is converted into sound by using the speaker in the headset, and a 3.5 mm or 6.35 mm interface is usually used. In this case, a channel switching circuit may be added to the wired headset that receives an analog signal, to transmit, by using the channel switching circuit, a left-channel analog signal to the earbud (which is determined based on the first detection result) that is determined to be worn on the right ear of the user, and transmit a right-channel analog signal to the earbud (which is determined based on the first detection result) that is determined to be worn on the left ear of the user, to exchange the left-channel audio and the right-channel audio.

If the headset is a wired headset that receives a digital signal, this type of headset first converts a received digital audio signal into an analog signal by using an independent digital-to-analog conversion module, and then converts the analog signal into sound by using the speaker for playing. A universal serial bus (universal serial bus, USB) interface, a Sony/Philips digital interconnect format (Sony/Philips digital interconnect format, S/PDIF) interface, or another type of interface is usually used. In this case, when performing digital-to-analog conversion, the wired headset that receives a digital signal may exchange a left-channel audio and a right-channel audio in the input to-be-played audio, and then play, by using the speaker, the to-be-played audio on which the left-channel and right-channel audio exchange operation is performed, to implement exchange of the left-channel audio and the right-channel audio.

If the headset is a conventional wireless Bluetooth headset, there is a connection line between two earbuds of the conventional wireless Bluetooth headset, and a Bluetooth module and a digital-to-analog conversion module are disposed in the headset. The headset first establishes a wireless connection to the execution device by using the Bluetooth module, receives a digital audio signal (namely, a to-be-played audio in a digital signal form) by using the Bluetooth module, converts the digital audio signal into an analog signal by using the digital-to-analog conversion module, and separately transmits a left-channel audio and a right-channel audio in an analog signal form to the two earbuds of the headset for playing by using speakers in the earbuds. Therefore, after receiving the to-be-played audio in a digital signal form by using the Bluetooth module, the headset may exchange the left-channel audio and the right-channel audio in the to-be-played audio, or may complete exchange of the left-channel audio and the right-channel audio when performing conversion from the digital signal to the analog signal by using the digital-to-analog conversion module.

If the headset is a true wireless Bluetooth headset, a connection line between two earbuds is removed from the true wireless Bluetooth headset. In a form, the two earbuds of the true wireless Bluetooth headset may be classified into a primary earbud and a secondary earbud. The primary earbud is responsible for establishing a Bluetooth connection to a sound source end of the execution device, and receiving dual-channel audio data. Then, the primary earbud separates data of a channel of the secondary earbud from the received signal, and sends the data to the secondary earbud through Bluetooth. After the primary earbud receives a to-be-played audio, audio data that is originally intended to be played by using the primary earbud may be transmitted to the secondary earbud, and audio data that is originally intended to be played by using the secondary earbud may be transmitted to the primary earbud, to complete exchange of the left-channel audio and the right-channel audio.

In another form, the two earbuds included in the true wireless Bluetooth headset are separately connected to the execution device (namely, a sound source end). In this case, the execution device may send a left-channel audio to the earbud that is determined based on the first detection result and that is worn on the right ear, and send a right-channel audio to the earbud that is determined based on the first detection result and that is worn on the left ear, to complete exchange of the left-channel audio and the right-channel audio. When the headset is in another form, a manner may alternatively be used to implement exchange of the left-channel audio and the right-channel audio. Examples are not enumerated herein.

In embodiments of this application, the sounding signal is transmitted by using the target earbud, the feedback signal corresponding to the sounding signal is obtained by using the target earbud, and whether the target earbud is worn on the left ear or the right ear of the user is determined based on the feedback signal. It can be learned from the foregoing solution that, in this application, a category of each earbud is not preset. Instead, after the user wears the earbud, whether the target earbud is worn on the left ear or the right ear is determined based on an actual wearing status of the user. In other words, the user does not need to view a mark on the earbud, and wear the headset based on the mark on the earbud, but may wear the headset randomly. This simplifies an operation of the user, and helps improve customer stickiness in this solution. In addition, an actual wearing status of each target earbud is detected according to an acoustic principle. Because a speaker and a microphone are usually disposed inside the headset, no additional hardware is required, and manufacturing costs are reduced. In addition, the frequency band of the first sounding signal is 8 kHz to 20 kHz. In other words, speakers in different headsets can accurately send first sounding signals, that is, the frequency band of the first sounding signal is not affected by a difference between different components, to help improve accuracy of a detection result.

2. Detect, in another manner, whether the target earbud is worn on the left ear or the right ear of the user

In this embodiment of this application, another manner is further provided to obtain the detection result corresponding to the target earbud. The detection result indicates whether the target earbud is worn on the left ear or the right ear. In other words, in step 303, the first detection result may be generated in any one of the following four manners. Correspondingly, in step 304, the second detection result may also be generated in any one of the following four manners.

In an implementation, in a plurality of application scenarios in which a user wears a headset, the user faces an electronic device (namely, a sound source end communicatively connected to the headset) with a display function. For example, when watching a video, the user faces a mobile phone/tablet computer. For another example, when the user plays a game, the user faces a computer or the like. Therefore, the first detection result/second detection result corresponding to the target earbud may be generated by comparing a location of the headset relative to a location of the electronic device that the user faces. Specifically, FIG. 13 is a schematic flowchart of generating a detection result corresponding to a target earbud in a data processing method according to an embodiment of this application. A method for generating a detection result corresponding to a target earbud provided in embodiments of this application may include the following steps.

1301: An execution device obtains an orientation of a lateral axis of an electronic device connected to a headset.

In this implementation, the execution device obtains the orientation of the lateral axis of the electronic device connected to the headset. The execution device may be the headset, or may be the electronic device connected to the headset.

Specifically, the execution device determines the orientation of the lateral axis of the electronic device based on a current orientation (orientation) of the electronic device connected to the headset, and the execution device may obtain vector coordinates of the lateral axis of the electronic device in the geographic coordinate system.

Further, the electronic device may be in different orientation modes when being used, where different orientation modes include a landscape mode (landscape mode) and a portrait mode (portrait mode). When the electronic device connected to the headset is in the landscape mode, the orientation of the lateral axis is parallel to a long side of the electronic device. When the electronic device connected to the headset is in the portrait mode, the orientation of the lateral axis is parallel to a short side of the electronic device.

A trigger occasion of step 1301 includes but is not limited to: after the headset is worn and establishes a communication connection to the electronic device; after the headset establishes a communication connection to the electronic device, the electronic device starts an application program that needs to play an audio; another type of trigger occasion; or the like.

1302: The execution device calculates a first included angle between a lateral axis of a target earbud and the lateral axis of the electronic device.

In this implementation, the execution device may obtain an orientation of the lateral axis of the target earbud by using a sensor disposed in the target earbud (namely, an earbud of the headset), that is, may obtain vector coordinates of the lateral axis of the target earbud in the geographic coordinate system, to calculate the first included angle between the lateral axis of the target earbud and the lateral axis of the electronic device. An origin corresponding to the lateral axis of the target earbud is on the target earbud.

It should be noted that, in this embodiment and subsequent embodiments, if the execution device and a data collection device are different devices, an instruction may be sent to the data collection device through information exchange, to instruct the data collection device to collect data, and the execution device receives the data sent by the data collection device. For example, if the execution device and the target earbud are different devices, the execution device may send an instruction to the target earbud, to instruct the target earbud to collect the orientation of the lateral axis of the target earbud, and send the orientation of the lateral axis of the target earbud to the execution device. If the execution device and the data collection device are a same device, data collection may be directly performed.

1303: The execution device determines, based on the first included angle, a detection result corresponding to the target earbud, where the detection result corresponding to the target earbud indicates that the target earbud is worn on the left ear or the right ear of a user.

In this implementation, after the execution device obtains the first included angle, if the first included angle is within a first preset range, the target earbud is determined to be worn in a preset direction of the user; or if the first included angle is beyond a first preset range, the target earbud is determined to be not worn in a preset direction of the user.

The preset direction indicates whether the target earbud is worn on the left ear or the right ear of the user. If the preset direction indicates that the target earbud is worn on the left ear of the user, not being worn in a preset direction of the user indicates that the target earbud is worn on the right ear of the user. If the preset direction indicates that the target earbud is worn on the right ear of the user, not being worn in a preset direction of the user indicates that the target earbud is worn on the left ear of the user.

A value of the first preset range needs to be determined with reference to factors such as a value of the preset direction and a manner of setting the lateral axis of the target earbud. For example, if the preset direction indicates that the target earbud is worn on the left ear of the user, and the lateral axis of the target earbud is perpendicular to a central axis of the head of the user, the first preset range may be o to 45 degrees, o to 60 degrees, o to 90 degrees, or another value. Examples are not enumerated herein. For another example, if the preset direction indicates that the target earbud is worn on the right ear of the user, and the lateral axis of the target earbud is perpendicular to a central axis of the head of the user, the first preset range may be 180 to 135 degrees, 180 to 120 degrees, 180 to 90 degrees, or another value. Examples are not enumerated herein.

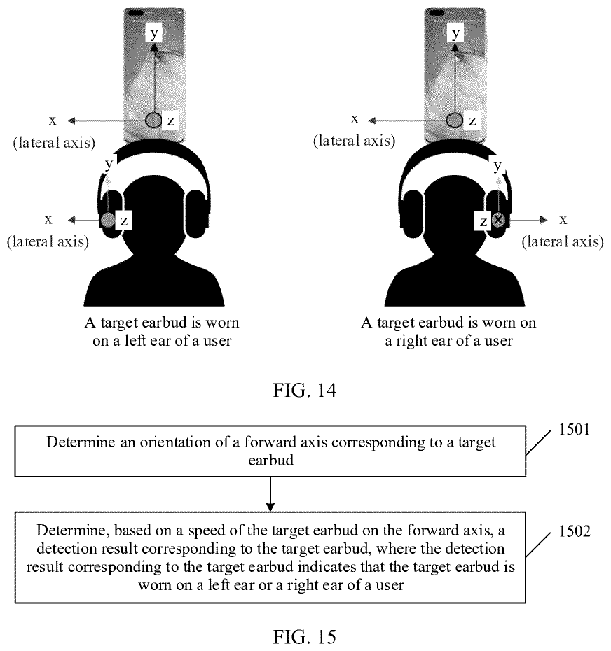

To more intuitively understand this solution, FIG. 14 is a schematic diagram of a principle of generating a detection result corresponding to a target earbud in a data processing method according to an embodiment of this application. FIG. 14 is described by using an example in which the electronic device connected to the headset is a mobile phone, a lateral axis of the mobile phone is parallel to a short side of the mobile phone, the lateral axis of the target earbud is perpendicular to the central axis of the head of the user, and the preset direction indicates that the target earbud is worn on the left ear of the user. The preset direction indicates that the target earbud is worn on the left ear of the user. As shown in FIG. 14, when the target earbud is worn on the left ear of the user, a value of the first included angle between the lateral axis of the target earbud and the lateral axis of the mobile phone is about o degrees. When the target earbud is worn on the left ear of the user, the value of the first included angle between the lateral axis of the target earbud and the lateral axis of the mobile phone is about 180 degrees. Therefore, the included angle between the lateral axis of the target earbud and the lateral axis of the mobile phone is compared, to learn an actual wearing status of the target earbud. It should be understood that the example in FIG. 14 is merely for ease of understanding this solution, and is not intended to limit this solution. It should be noted that the implementation shown in FIG. 13 may be used to generate a first detection result corresponding to the target earbud, or may be used to generate a second detection result corresponding to the target earbud.

In this implementation, the actual wearing status of the target earbud is detected by using a location, relative to the headset, of the electronic device connected to the headset, and the user does not need to perform an additional operation. Instead, detection is automatically performed when the user uses the headset, to reduce complexity of using the headset by the user. In addition, another manner of obtaining a detection result of the target earbud is provided, to improve implementation flexibility of this solution.

In another implementation, because a walking direction of a person in most scenarios is consistent with an orientation of the face (that is, almost all people walk forward), an actual wearing status of the target earbud may be determined based on a positive or negative value of a speed value of the headset on a forward axis when the person is walking, that is, the first detection result/second detection result corresponding to the target earbud is generated. Specifically, FIG. 15 is another schematic flowchart of generating a detection result corresponding to a target earbud in a data processing method according to an embodiment of this application. A method for generating a detection result corresponding to a target earbud provided in embodiments of this application may include the following steps.

1501: An execution device determines an orientation of a forward axis corresponding to a target earbud.

In this implementation, the execution device presets an axis direction of a motion sensor in the target earbud (that is, one of two earbuds of a headset) as the orientation of the forward axis corresponding to the target earbud. When the target earbud starts to move, the execution device may obtain, by using the motion sensor in the target earbud, the orientation of the forward axis corresponding to the target earbud.

The forward axis is perpendicular to a face plane when the headset is worn, and the orientation of the forward axis is parallel to a face orientation. The motion sensor may specifically be represented as an inertia measurement unit (inertial measurement unit, IMU), another type of motion sensor, or the like.

Specifically, the orientation of the forward axis corresponding to the target earbud is described with reference to FIG. 16. FIG. 16 is a schematic diagram of determining an orientation of a forward axis corresponding to a target earbud in a data processing method according to an embodiment of this application. A left figure in FIG. 16 shows the orientation of the forward axis corresponding to the target earbud when the headset is in a completely vertical state, that is, when a rotation angle of the headset is o. Because a headphone has different rotation angles (as shown in a right figure in FIG. 16) when being worn, the execution device may calculate a rotation angle of the headset in a pitch direction based on a reading of a gravity acceleration sensor. It is specified that when the rotation angle (angle θ shown in the right figure in FIG. 16) of the headset is greater than a preset angle threshold, another axis is selected as the forward axis. The “another axis” is neither the “forward axis” nor “an axis parallel to a connection line between two ears of a user”. Optionally, an included angle between the “another axis” and an axis directly obtained by the inertia measurement unit is the angle θ (refer to the right figure in FIG. 16). The preset angle threshold may be 60 degrees, 80 degrees, 90 degrees, another value, or the like. As shown in the right figure in FIG. 16, when a headband of the headphone is worn on the back of the head, a reverse direction of an original y axis is set as the forward axis.

1502: The execution device determines, based on a speed of the target earbud on the forward axis, a detection result corresponding to the target earbud, where the detection result corresponding to the target earbud indicates that the target earbud is worn on the left ear or the right ear of the user.

In this implementation, when the target earbud detects that the target earbud is in a moving state, the speed of the target earbud on the forward axis is calculated in a preset time window. If the speed of the target earbud on the forward axis is positive, the execution device determines that the detection result corresponding to the target earbud is a first preset wearing status. If the speed of the target earbud on the forward axis is negative, the execution device determines that the detection result corresponding to the target earbud is a second preset wearing status.

The first preset wearing status and the second preset wearing status are two different wearing statuses. For example, if the first preset wearing status indicates that an earbud A is worn on the right ear of the user, and an earbud B is worn on the left ear of the user, the second preset wearing status indicates that the earbud A is worn on the left ear of the user, and the earbud B is worn on the right ear of the user.

To more intuitively understand this solution, FIG. 17 is a schematic diagram of another principle of generating a detection result corresponding to a target earbud in a data processing method according to an embodiment of this application. As shown in a left figure in FIG. 17, the earbud A is shown in the left figure of FIG. 17, and the earbud B is not shown in the figure. When a speed of the earbud A on the forward axis is positive, it is determined that the entire headset is in the first preset wearing status, that is, the earbud A is worn on the right ear of the user, and the earbud B is worn on the left ear of the user. The earbud B is shown in the left figure in FIG. 17, and the earbud A is not shown in the figure. When a speed of the earbud Bon the forward axis is positive, it is determined that the entire headset is in the second preset wearing status, that is, the earbud A is worn on the left ear of the user, and the earbud B is worn on the right ear of the user. It should be understood that the example in FIG. 17 is merely for ease of understanding of this solution, and is not intended to limit this solution.

In this implementation, in a scenario in which the user wears the headset and moves, an actual wearing status of each earbud can be detected by using a motion sensor disposed in the headset. This provides a simple method for detecting the actual wearing status of the earbud, and further improves implementation flexibility of this solution.

In another implementation, if the user wears a smart band or a smart watch, and the headset is an over-ear headset or an on-ear headset, a first detection result/second detection result corresponding to the target earbud may further be generated based on a moment at which the headset is worn and a distance between the smart band or the smart watch and the two earbuds.

Specifically, the electronic device (namely, the smart band or the smart watch) may determine, by using a configured motion sensor, whether the electronic device is worn on the left hand or the right hand, to obtain a location parameter (namely, left or right) corresponding to the electronic device. The electronic device sends the location parameter to the headset. When the user wears the headset, each earbud of the headset may obtain a distance between the earbud and the electronic device, that is, distances between the electronic device and the two earbuds can be separately obtained. The headset generates, based on the received location parameter and the distances between the two earbuds and the electronic device, a detection result corresponding to each earbud. If the electronic device is worn on the left hand, it is determined that one of the two earbuds that is close to the electronic device is worn on the left ear of the user, and one of the two earbuds that is far away from the electronic device is worn on the right ear of the user. If the electronic device is worn on the right hand, it is determined that one of the two earbuds that is close to the electronic device is worn on the right ear of the user, and one of the two earbuds that is far away from the electronic device is worn on the left ear of the user.

In this implementation, in the scenario in which the user wears the smart band or the smart watch, the actual wearing status of each earbud can be detected by using the smart band or the smart watch. This provides another method for detecting the actual wearing status of the earbud, and further improves implementation flexibility of this solution.

In another implementation, when the headset is an over-ear headset or an on-ear headset, a touch point of a finger left by the user on a surface of the headset can be detected outside each earbud (which may also be referred to as an earbud). For a same earbud, when the same earbud is held by different hands, left touch points are approximately vertically axisymmetric to the headset. In this case, when the headset is an over-ear headset or an on-ear headset, whether the target earbud is worn on the left ear or the right ear may further be determined by detecting whether the hand holding the target earbud is the left hand or the right hand when the target earbud is worn.

Specifically, the execution device may detect at least three touch points by using a touch sensor outside a target earbud, and record location information corresponding to each touch point, to determine whether a hand that touches the target earbud is the left hand or the right hand. If the hand that touches the target earbud is the left hand, it is determined that the target earbud is worn on the left ear of the user; or if the hand that touches the target earbud is the right hand, it is determined that the target earbud is worn on the right ear of the user.

More specifically, in an implementation, the execution device may determine, from the at least three touch points based on the location information corresponding to each of the at least three touch points, a touch point corresponding to the thumb and a touch point corresponding to the index finger. The execution device may obtain an orientation of a vertical axis of the headset, and obtain a second included angle between a target vector and the vertical axis of the headset, where the target vector is a vector pointing from the thumb to the index finger. The execution device further determines, based on the second included angle, whether the hand touching the target earbud is the left hand or the right hand, to determine whether the target earbud is worn on the left ear or the right ear of the user. It should be noted that the descriptions herein are merely to prove implementability of this solution, and another manner may alternatively be used to determine, based on the location information corresponding to each of the at least three touch points, whether the hand touching the target earbud is the left hand or the right hand. Examples are not enumerated herein.

The vertical axis of the headset is specified in advance. For example, a direction of the vertical axis of the headset may be determined based on a flip angle of the headset in the pitch direction. Further, the execution device may obtain the flip angle of the headset in the pitch direction by reading a reading of the gravity acceleration sensor of the headset.

More specifically, the following describes a determining process in terms of the thumb and the index finger. In an implementation, the execution device obtains a length of an arc formed between every two touch points in the at least three touch points, to determine, from the at least three touch points based on the length of the arc formed between every two touch points, the touch point corresponding to the thumb and the touch point corresponding to the index finger. It should be noted that the execution device may alternatively determine, in another manner, the touch point corresponding to the thumb and the touch point corresponding to the index finger from the at least three touch points. Examples are not enumerated herein.

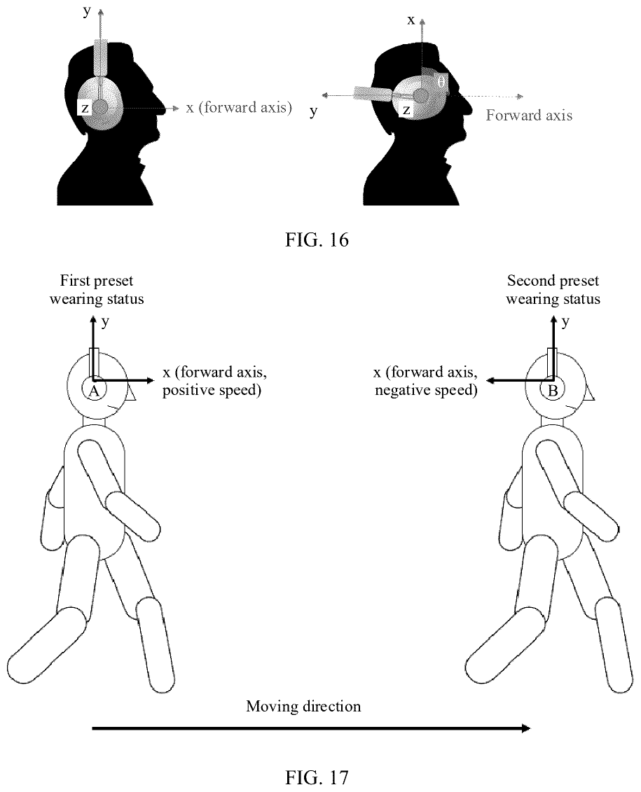

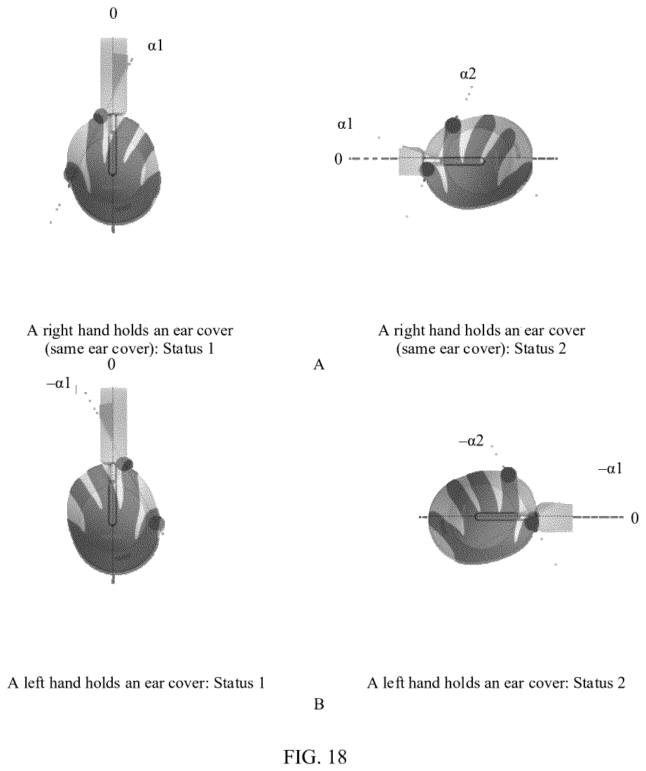

To more intuitively understand this solution, FIG. 18 is a schematic diagram of still another principle of generating a detection result corresponding to a target earbud in a data processing method according to an embodiment of this application. As shown in FIG. 18, upper two figures in FIG. 18 show a value range of the second included angle formed by touching the target earbud (which may also be referred to as an ear cover) by using the right hand, and a value of the second included angle is within a range of (α1, α2). In other words, when the value of the second included angle corresponding to the target earbud is within a range of (α1, α2), it indicates that the target earbud is worn on the right ear of the user. Lower two figures in FIG. 18 show a value range of the second included angle formed by touching the target earbud by using the left hand, and a value of the second included angle is within a range of (α1, α2). In other words, when the value of the second included angle corresponding to the target earbud is within a range of (−α1, −α2), it indicates that the target earbud is worn on the left ear of the user. It should be understood that the example in FIG. 18 is merely for ease of understanding this solution, and is not intended to limit this solution.

In this implementation, in a scenario in which the user wears an over-ear headset or an on-ear headset, an actual wearing status of each earbud can alternatively be detected by detecting whether the hand holding the target earbud is the left hand or the right hand when the target earbud is worn. This provides still another method for detecting the actual wearing status of the earbud, and further improves implementation flexibility of this solution.

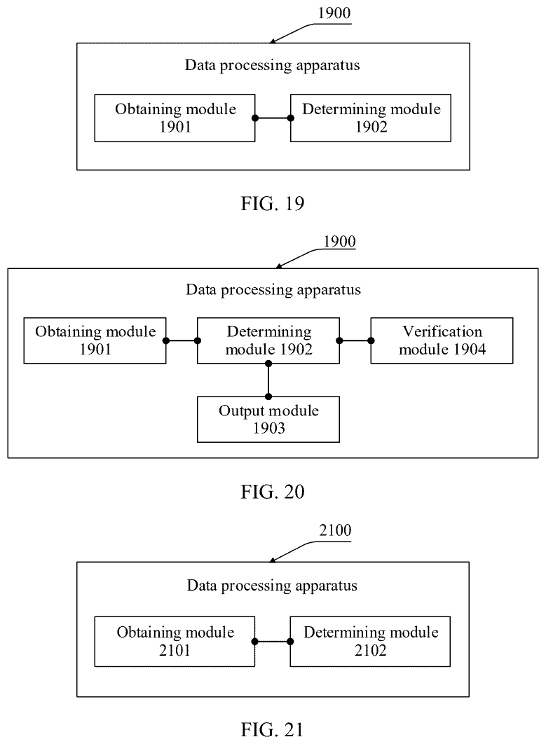

According to the embodiments corresponding to FIG. 1 to FIG. 18, to better implement the foregoing solutions in embodiments of this application, the following further provides related devices configured to implement the foregoing solutions. FIG. 19 is a schematic diagram of a structure of a data processing apparatus according to an embodiment of this application. One headset includes two target earbuds, and a data processing apparatus 1900 includes: an obtaining module 1901, configured to obtain a first feedback signal corresponding to a first sounding signal, where the first sounding signal is an audio signal transmitted by using the target earbud, a frequency band of the first sounding signal is 8 kHz to 20 kHz, and the first feedback signal includes a reflected signal corresponding to the first sounding signal; and a determining module 1902, configured to: when it is detected that the headset is worn, determine, based on the first feedback signal, a first detection result corresponding to the target earbud, where the first detection result indicates that the target earbud is worn on a left ear or a right ear.

In a possible design, the first sounding signal is an audio signal that varies at different frequencies, and the first sounding signal has same signal strength at the different frequencies.

In a possible design, when any one or more of the following cases are detected, it is considered that it is detected that the headset is worn: it is detected that an application program of a preset type is opened, it is detected that a screen of an electronic device communicatively connected to the headset is on, or it is detected that the target earbud is placed on an ear.

In a possible design, the obtaining module 1901 is further configured to obtain a plurality of pieces of target feature information corresponding to a plurality of wearing angles of the target earbud. Each piece of target feature information includes feature information of a second feedback signal corresponding to one wearing angle of the target earbud, the second feedback signal includes a reflected signal corresponding to a second sounding signal, and the second sounding signal is an audio signal transmitted by using the target earbud. The determining module 1902 is specifically configured to determine the first detection result based on the first feedback signal and the plurality of pieces of target feature information.

In a possible design, FIG. 20 is a schematic diagram of another structure of the data processing apparatus according to an embodiment of this application. The obtaining module 1901 is further configured to obtain a second detection result corresponding to the target earbud. The second detection result indicates that each target earbud is worn on the left ear or the right ear, and the second detection result is obtained by detecting the target earbud for another time. The data processing apparatus 1900 further includes an output module 1903, configured to: if the first detection result is inconsistent with the second detection result, and a type of a to-be-played audio belongs to a preset type, output third prompt information, where the third prompt information is used to query a user whether to correct a category of the target earbud, the to-be-played audio is an audio that needs to be played by using the target earbud, and the category of the target earbud is that the target earbud is worn on the left ear or the right ear.

In a possible design, the preset type includes any one or a combination of the following: a stereo audio, an audio from a video-type application program, an audio from a game-type application program, and an audio carrying direction information.

Refer to FIG. 20. In a possible design, the data processing apparatus 1900 further includes a verification module 1904, configured to make a prompt tone by using the target earbud, where the prompt tone is used to verify correctness of the first detection result.

In a possible design, the two target earbuds include a first earbud and a second earbud, the first earbud is determined to be worn in a first direction, and the second earbud is determined to be worn in a second direction. The verification module 1904 is specifically configured to output first prompt information through a display interface when making a first prompt tone by using the first earbud, where the first prompt information indicates whether the first direction corresponds to the left ear or the right ear; and output second prompt information through the display interface when making a second prompt tone by using the second earbud, where the second prompt information indicates whether the second direction corresponds to the left ear or the right ear.

In a possible design, the headset is an over-ear headset or an on-ear headset, the two target earbuds includes a first earbud and a second earbud, a first audio collection apparatus is disposed in the first earbud, and a second audio collection apparatus is disposed in the second earbud. When the headset is worn, the first audio collection apparatus corresponds to a helix area of a user, and the second audio collection apparatus corresponds to a concha area of the user; or when the headset is worn, the first audio collection apparatus corresponds to a concha area of a user, and the second audio collection apparatus corresponds to a helix area of the user.

In a possible design, the determining module 1902 is specifically configured to determine a first category of the target earbud based on the feedback signal and an ear transfer function, where the headset is an over-ear headset or an on-ear headset, and the ear transfer function is an ear auricle transfer function EATF; or the headset is an in-ear headset, a semi-in-ear headset, or an over-ear headset, and the ear transfer function is an ear canal transfer function ECTF.

In a possible design, the first feedback signal includes the reflected signal corresponding to the first sounding signal. The determining module 1902 is further configured to: when it is detected that the target earbud is worn, determine, based on signal strength of the first feedback signal, target wearing information corresponding to the target earbud, where the target wearing information indicates wearing tightness of the target earbud.

It should be noted that content such as information exchange or an execution process between the modules/units in the data processing apparatus 1900 is based on a same concept as method embodiments corresponding to FIG. 1 to FIG. 18 in this application. For specific content, refer to descriptions in the method embodiments in this application. Details are not described herein again.

FIG. 21 is a schematic diagram of still another structure of a data processing apparatus according to an embodiment of this application. One headset includes two target earbuds, and a data processing apparatus 2100 may include: an obtaining module 2101, configured to obtain a first feedback signal corresponding to a first sounding signal, where the first sounding signal is an audio signal transmitted by using the target earbud, the first feedback signal includes a reflected signal corresponding to the first sounding signal, the obtaining module 2101 is further configured to: when it is detected that the headset is worn, obtain a target wearing angle corresponding to the first feedback signal, where the target wearing angle is a wearing angle of the target earbud when the first feedback signal is collected, and the obtaining module 2101 is further configured to obtain target feature information corresponding to the target wearing angle, where the target feature information indicates feature information of a feedback signal obtained when the target earbud is at the target wearing angle; and a determining module 2102, configured to determine, based on the first feedback signal and the target feature information, a first detection result corresponding to the target earbud, where the first detection result indicates that each target earbud is worn on a left ear or a right ear.

In a possible design, both a frequency band of the first sounding signal and a frequency band of a second sounding signal are 8 kHz to 20 kHz.

In a possible design, the first sounding signal is an audio signal that varies at different frequencies, and the first sounding signal has same signal strength at the different frequencies.

In a possible design, when any one or more of the following cases are detected, it is considered that it is detected that the headset is worn: it is detected that an application program of a preset type is opened, it is detected that a screen of an electronic device communicatively connected to the headset is on, or it is detected that the target earbud is placed on an ear.

It should be noted that content such as information exchange or an execution process between the modules/units in the data processing apparatus 2100 is based on a same concept as method embodiments corresponding to FIG. 1 to FIG. 18 in this application. For specific content, refer to descriptions in the method embodiments in this application. Details are not described herein again.

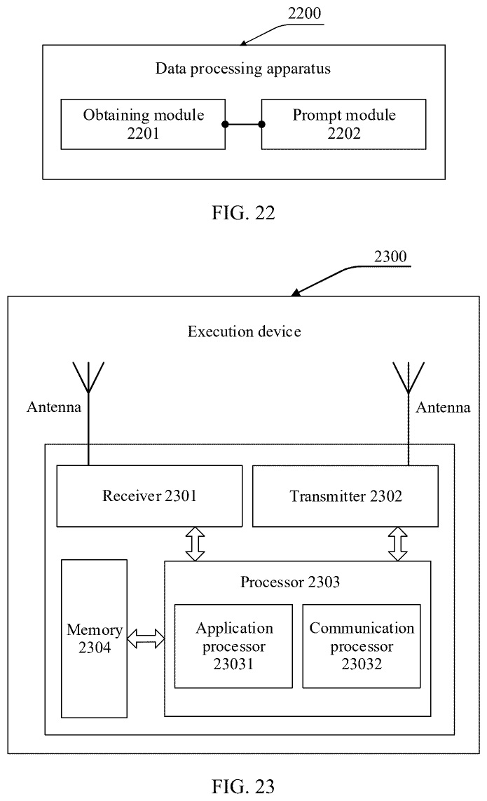

FIG. 22 is a schematic diagram of yet another structure of a data processing apparatus according to an embodiment of this application. One headset includes two target earbuds, and a data processing apparatus 2200 may include: an obtaining module 2201, configured to obtain a first detection result corresponding to the target earbud, where the first detection result indicates that each target earbud is worn on a left ear or a right; and a prompt module 2202, configured to make a prompt tone by using the target earbud, where the prompt tone is used to verify correctness of the first detection result.

In a possible design, the obtaining module 2201 is further configured to obtain a second detection result corresponding to the target earbud. The second detection result indicates that each target earbud is worn on the left ear or the right ear, and the second detection result is obtained by detecting the target earbud for another time. The prompt module 2202 is further configured to: if the first detection result is inconsistent with the second detection result, and a type of a to-be-played audio belongs to a preset type, output third prompt information, where the third prompt information is used to query a user whether to correct a category of the target earbud, the to-be-played audio is an audio that needs to be played by using the target earbud, and the category of the target earbud is that the target earbud is worn on the left ear or the right ear.

It should be noted that content such as information exchange or an execution process between the modules/units in the data processing apparatus 2200 is based on a same concept as method embodiments corresponding to FIG. 1 to FIG. 18 in this application. For specific content, refer to descriptions in the method embodiments in this application. Details are not described herein again.

The following describes an execution device provided in an embodiment of this application. FIG. 23 is a schematic diagram of a structure of an execution device according to an embodiment of this application. An execution device 2300 may specifically be represented as a headset or an electronic device, namely, a virtual reality (virtual reality, VR) device, a mobile phone, a tablet, a notebook computer, an intelligent wearable device, or the like, connected to the headset. This is not limited herein. The data processing apparatus 1900 described in the embodiment corresponding to FIG. 19 or FIG. 20 may be deployed on the execution device 2300, and is configured to implement a function of the execution device in the embodiments corresponding to FIG. 1 to FIG. 18. Specifically, the execution device 2300 includes a receiver 2301, a transmitter 2302, a processor 2303, and a memory 2304 (there may be one or more processors 2303 in the execution device 2300, and one processor is used as an example in FIG. 23). The processor 2303 may include an application processor 23031 and a communication processor 23032. In some embodiments of this application, the receiver 2301, the transmitter 2302, the processor 2303, and the memory 2304 may be connected by using a bus or in another manner.

The memory 2304 may include a read-only memory and a random access memory, and provide instructions and data to the processor 2303. A part of the memory 2304 may further include a non-volatile random access memory (non-volatile random access memory, NVRAM). The memory 2304 stores a processor and operation instructions, an executable module or a data structure, a subset thereof, or an extended set thereof. The operation instructions may include various operation instructions for implementing various operations.

The processor 2303 controls an operation of the execution device. During specific application, components of the execution device are coupled to each other by using a bus system. In addition to a data bus, the bus system may further include a power bus, a control bus, a status signal bus, and the like. However, for clear description, various types of buses in the figure are marked as the bus system.

The method disclosed in the foregoing embodiments of this application may be applied to the processor 2303, or may be implemented by the processor 2303. The processor 2303 may be an integrated circuit chip and has a signal processing capability. In an implementation process, the steps of the foregoing method may be implemented by using an integrated logic circuit of hardware in the processor 2303, or instructions in a form of software. The processor 2303 may be a general-purpose processor, a digital signal processor (digital signal processor, DSP), a microprocessor, or a microcontroller, and may further include an application-specific integrated circuit (application-specific integrated circuit, ASIC), a field programmable gate array (field programmable gate array, FPGA) or another programmable logic device, a discrete gate or transistor logic device, or a discrete hardware assembly. The processor 2303 may implement or perform the methods, steps, and logical block diagrams that are disclosed in embodiments of this application. The general-purpose processor may be a microprocessor, or the processor may be any conventional processor or the like. Steps of the method disclosed with reference to embodiments of this application may be directly executed and accomplished by using a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory 2304, and the processor 2303 reads information in the memory 2304, and completes the steps of the foregoing methods in combination with the hardware in the processor 2303.

The receiver 2301 may be configured to: receive input digital or character information, and generate a signal input related to a setting related to and function control of the execution device. The transmitter 2302 may be configured to output digital or character information through a first interface. The transmitter 2302 may be further configured to send an instruction to a disk pack through the first interface, to modify data in the disk pack. The transmitter 2302 may further include a display device, for example, a display.

In this embodiment of this application, the application processor 23031 in the processor 2303 is configured to perform the data processing method performed by the execution device in the embodiments corresponding to FIG. 1 to FIG. 18. It should be noted that a specific manner in which the application processor 23031 performs the foregoing steps is based on a same concept as the method embodiments corresponding to FIG. 1 to FIG. 18 in this application. Technical effect brought by the method is the same as technical effect brought by the method embodiments corresponding to FIG. 1 to FIG. 18 in this application. For specific content, refer to the descriptions in the foregoing method embodiments in this application. Details are not described herein again.

An embodiment of this application further provides a computer program product. When the computer program product runs on a computer, the computer is enabled to perform the steps performed by the execution device in the method described in the embodiments shown in FIG. 1 to FIG. 18.

An embodiment of this application further provides a computer-readable storage medium. The computer-readable storage medium stores a program used for signal processing. When the program is run on a computer, the computer is enabled to perform the steps performed by the execution device in the method described in the embodiments shown in FIG. 1 to FIG. 18.

The data processing apparatus, the neural network training apparatus, the execution device, and the training device in embodiments of this application may specifically be chips. The chip includes a processing unit and a communication unit. The processing unit may be, for example, a processor, and the communication unit may be, for example, an input/output interface, a pin, or a circuit. The processing unit may execute computer-executable instructions stored in a storage unit, so that a chip performs the data processing method described in the embodiments shown in FIG. 1 to FIG. 18. Optionally, the storage unit is a storage unit in the chip, for example, a register or a buffer. Alternatively, the storage unit may be a storage unit in a wireless access device but outside the chip, for example, a read-only memory (read-only memory, ROM), another type of static storage device that can store static information and instructions, or a random access memory (random access memory, RAM).

The processor mentioned above may be a general-purpose central processing unit, a microprocessor, an ASIC, or one or more integrated circuits for controlling program execution in the method in the first aspect.

In addition, it should be noted that the described apparatus embodiment is merely an example. The units described as separate parts may or may not be physically separate, and parts displayed as units may or may not be physical units, may be located in one position, or may be distributed on a plurality of network units. Some or all the modules may be selected based on actual requirements to achieve the objectives of the solutions of embodiments. In addition, in the accompanying drawings of the apparatus embodiments provided by this application, connection relationships between modules indicate that the modules have communication connections with each other, which may specifically be implemented as one or more communication buses or signal cables.

Based on the descriptions of the foregoing implementations, a person skilled in the art may clearly understand that this application may be implemented by software in addition to necessary universal hardware, or by special-purpose hardware, including a special-purpose integrated circuit, a special-purpose CPU, a special-purpose memory, a special-purpose component, and the like. Generally, any functions that can be performed by a computer program can be easily implemented by using corresponding hardware. Moreover, a specific hardware structure used to achieve a same function may be in various forms, for example, in a form of an analog circuit, a digital circuit, or a special-purpose circuit. However, as for this application, software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (which may be a personal computer, a training device, or a network device) to perform the methods in embodiments of this application.

All or some of the foregoing embodiments may be implemented by using software, hardware, firmware, or any combination thereof. When software is used to implement embodiments, all or a part of embodiments may be implemented in a form of a computer program product.

The computer program product includes one or more computer instructions. When the computer program instructions are loaded and executed on the computer, the procedure or functions according to embodiments of this application are all or partially generated. The computer may be a general-purpose computer, a special-purpose computer, a computer network, or other programmable apparatuses. The computer instructions may be stored in a computer-readable storage medium, or may be transmitted from a computer-readable storage medium to another computer-readable storage medium. For example, the computer instructions may be transmitted from a website, a computer, a training device, or a data center to another website, computer, training device, or data center in a wired (for example, a coaxial cable, an optical fiber, or a digital subscriber line (DSL)) or wireless (for example, infrared, radio, or microwave) manner. The computer-readable storage medium may be any usable medium that can be stored by a computer, or a data storage device, such as a training device or a data center, integrating one or more usable media. The usable medium may be a magnetic medium (for example, a floppy disk, a hard disk, or a magnetic tape), an optical medium (for example, a DVD), a semiconductor medium (for example, a solid-state disk (Solid-State Disk, SSD)), or the like.

1-26. (canceled)

27. A method, comprising:
obtaining a first feedback signal corresponding to a first sounding signal, wherein the first sounding signal is an audio signal transmitted using a target earbud of a headset, a frequency band of the first sounding signal is 8 kHz to 20 kHz, and the first feedback signal comprises a reflected signal corresponding to the first sounding signal; and
in response to the headset being worn, determining, based on the first feedback signal, a first detection result corresponding to the target earbud, wherein the first detection result indicates that the target earbud is worn on a left ear or a right ear.

28. The method according to claim 27, wherein the first sounding signal is an audio signal that varies at different frequencies, and the first sounding signal has a same signal strength at the different frequencies.

29. The method according to claim 27, the headset is considered being worn in response to an application program of a preset type being opened, a screen of an electronic device communicatively connected to the headset being on, or the target earbud being placed on an ear.

30. The method according to claim 27, wherein the method further comprises:
obtaining a plurality of pieces of target feature information corresponding to a plurality of wearing angles of the target earbud, wherein each piece of target feature information comprises feature information of a second feedback signal corresponding to one wearing angle of the target earbud, the second feedback signal comprises a reflected signal corresponding to a second sounding signal, and the second sounding signal is an audio signal transmitted using the target earbud; and
determining, based on the first feedback signal, the first detection result corresponding to the target earbud comprises determining the first detection result based on the first feedback signal and the plurality of pieces of target feature information.

31. The method according to claim 27, further comprising, after determining the first detection result corresponding to the target earbud:
obtaining a second detection result corresponding to the target earbud, wherein the second detection result indicates that each target earbud is worn on the left ear or the right ear, and the second detection result is obtained by detecting the target earbud for another time; and
in response to the first detection result being inconsistent with the second detection result and a type of a to-be-played audio belongs to a preset type, outputting third prompt information, wherein the third prompt information is used to query a user whether to correct a category of the target earbud, the to-be-played audio is an audio designated to be played by using the target earbud, and the category of the target earbud is that the target earbud is worn on the left ear or the right ear.

32. The method according to claim 31, wherein the preset type comprises any one or a combination of the following: a stereo audio, an audio from a video-type application program, an audio from a game-type application program, or an audio carrying direction information.

33. The method according to claim 27, further comprising, after determining the first detection result corresponding to the target earbud:
making a prompt tone using the target earbud, wherein the prompt tone is used to verify correctness of the first detection result.

34. The method according to claim 33, wherein the headset comprises a first earbud and a second earbud, the first earbud is configured to be worn in a first direction, the second earbud is configured to be worn in a second direction, and the making the prompt tone by using the target earbud comprises:
outputting first prompt information through a display interface in response to the first earbud being used to make a first prompt tone, wherein the first prompt information indicates whether the first direction corresponds to the left ear or the right ear; and
outputting second prompt information through the display interface in response to the second earbud being used to make a second prompt tone, wherein the second prompt information indicates whether the second direction corresponds to the left ear or the right ear.

35. The method according to claim 27, wherein:
the headset is an over-ear headset or an on-ear headset, the target earbud comprises a first earbud and a second earbud, a first audio collection apparatus is disposed in the first earbud, and a second audio collection apparatus is disposed in the second earbud; and
the first audio collection apparatus corresponds to a helix area of a user and the second audio collection apparatus corresponds to a concha area of the user, or the first audio collection apparatus corresponds to the concha area of a user and the second audio collection apparatus corresponds to the helix area of the user.

36. The method according to claim 27, wherein determining, based on the first feedback signal, the first detection result corresponding to the target earbud comprises:
determining the first detection result based on the first feedback signal and an ear transfer function, wherein
the headset is an over-ear headset or an on-ear headset and the ear transfer function is an ear auricle transfer function (EATF), or
the headset is an in-ear headset, a semi-in-ear headset, or an over-ear headset, and the ear transfer function is an ear canal transfer function (ECTF).

37. The method according to claim 27, wherein:
the first feedback signal comprises the reflected signal corresponding to the first sounding signal; and
the method further comprises:
in response to the target earbud being worn, determining, based on signal strength of the first feedback signal, target wearing information corresponding to the target earbud, wherein the target wearing information indicates a wearing tightness of the target earbud.

38. A method, comprising:
obtaining a first detection result corresponding to a target earbud of headset, wherein the first detection result indicates that each target earbud is worn on a left ear or a right ear; and
making a prompt tone by using the target earbud, wherein the prompt tone is used to verify correctness of the first detection result.

39. The method according to claim 38, further comprising, after obtaining the first detection result corresponding to the target earbud:
obtaining a second detection result corresponding to the target earbud, wherein the second detection result indicates that each target earbud is worn on the left ear or the right ear, and the second detection result is obtained by detecting the target earbud for another time; and
in response to the first detection result being inconsistent with the second detection result and a type of a to-be-played audio belonging to a preset type, outputting third prompt information, wherein the third prompt information is used to query a user whether to correct a category of the target earbud, the to-be-played audio is an audio that is designated to be played using the target earbud, and the category of the target earbud is that the target earbud is worn on the left ear or the right ear.

40. The method according to claim 39, wherein the preset type comprises any one or a combination of the following: a stereo audio, an audio from a video-type application program, an audio from a game-type application program, or an audio carrying direction information.

41. An electronic device, comprising:
at least one processor; and
at least one memory with instructions stored thereon, wherein the instructions, when executed by the at least one processor, enable the electronic device to perform:
obtaining a first feedback signal corresponding to a first sounding signal, wherein the first sounding signal is an audio signal transmitted by using a target earbud of the electronic device, a frequency band of the first sounding signal is 8 kHz to 20 kHz, and the first feedback signal comprises a reflected signal corresponding to the first sounding signal; and
in response to the electronic device being worn, determining, based on the first feedback signal, a first detection result corresponding to the target earbud, wherein the first detection result indicates that the target earbud is worn on a left ear or a right ear.

42. The electronic device according to claim 41, wherein the first sounding signal is an audio signal that varies at different frequencies, and the first sounding signal has same signal strength at the different frequencies.

43. The electronic device according to claim 41, wherein the electronic device is considered being worn in response to an application program of a preset type being opened, a screen of a further electronic device communicatively connected to the electronic device being on, or the target earbud being placed on an ear.

44. The electronic device according to claim 41, wherein the instructions, when executed by the at least one processor further enable the electronic device to perform:
obtaining a plurality of pieces of target feature information corresponding to a plurality of wearing angles of the target earbud, wherein each piece of target feature information comprises feature information of a second feedback signal corresponding to one wearing angle of the target earbud, the second feedback signal comprises a reflected signal corresponding to a second sounding signal, and the second sounding signal is an audio signal transmitted by using the target earbud; and
determining the first detection result based on the first feedback signal and the plurality of pieces of target feature information.

45. The electronic device according to claim 41, wherein the instructions, when executed by the at least one processor further enable the electronic device to perform:
obtaining a second detection result corresponding to the target earbud, wherein the second detection result indicates that each target earbud is worn on the left ear or the right ear, and the second detection result is obtained by detecting the target earbud for another time; and
in response to the first detection result being inconsistent with the second detection result and a type of a to-be-played audio belonging to a preset type, outputting third prompt information, wherein the third prompt information is used to query a user whether to correct a category of the target earbud, the to-be-played audio is an audio designated to be played using the target earbud, and the category of the target earbud is that the target earbud is worn on the left ear or the right ear.

46. The electronic device according to claim 45, wherein the preset type comprises any one or a combination of the following: a stereo audio, an audio from a video-type application program, an audio from a game-type application program, or an audio carrying direction information.
